(19) United States
(12) Patent Application Publication
(10) Pub. No.: US 2010/0002196 A1
(43) Pub. Date: Jan. 7, 2010

(54) PROJECTION SYSTEM

(75) Inventors: Ho Lu, Taipei (TW); Shih-Po Yeh, Taipei (TW); Tsung-Hsien Wu, Taipei (TW); Peng-Fan Chen, Taipei (TW)

Correspondence Address: KIRTON AND MCCONKIE, 60 EAST SOUTH TEMPLE,, SUITE 1800, SALT LAKE CITY, UT, 84111, US

(73) Assignee: ARIMA PHOTOVOLTAIC & OPTICAL CORPORATION, Taipei (TW)

(21) Appl. No.: 12/271,366

(22) Filed: Nov. 14, 2008

(30) Foreign Application Priority Data
Jul. 1, 2008 (TW) 097124775

(51) Int. Cl. G03B 21/14

(52) U.S. Cl. 353/31; 353/33

(57) ABSTRACT

A projection system includes a multi-laser beam generator, a beam switching device, a split beam projecting device and a transmissive light valve. The multi-laser beam generator selectively generates a red beam, a green beam and a blue beam. The beam switching device receives the red, green and blue beams, splits the red, green and blue beams into a plurality of light beams of different angles, and directs the red, green and blue beams of the different angles into a common optical path. The split beam projecting device includes a plurality of micro-lenses. The transmissive light valve has a plurality of pixels for receiving the red, green and blue beams that are guided by the split beam projecting device. The red, green and blue beams of the different angles are received by the micro-lenses and guided onto the pixels of the transmissive light valve for imagining on the pixels.

### FIELD OF THE INVENTION

The present invention relates to a projection system, and more particularly to a projection system having a single-panel transmissive light valve.

### BACKGROUND OF THE INVENTION

Single-panel projection systems are generally classified into two types, i.e. a single-panel transmissive projection system and a single-panel reflective projection system. Nowadays, with increasing advancement of electronic industries, the single-panel projection systems are designed in views of high brightness, high resolution, minimization and low power consumption. Due of some inherent drawbacks, the single-panel transmissive projection system and the single-panel reflective projection system still fail to successfully comply with the requirements of high brightness, high resolution, minimization and low power consumption.

Generally, the light sources used in the conventional transmissive or reflective single-panel projection systems are tungsten-halogen lamps, metal halide lamps, super high pressure mercury lamps and xenon lamps. These light sources, however, have several disadvantages such as brightness decay, large volume, high power consumption, and so on. Under this circumstance, the overall volume and the overall weight are very bulky. Take an ultra high pressure mercury lamp for example. When strong light beams are emitted by the ultra high pressure mercury lamp, useless ultraviolet rays and infrared rays are simultaneously generated. The ultraviolet rays usually degrade the internal components of the projection system. The infrared rays are detrimental to the performance of the resulting colors. In addition, since the life of the ultra high pressure mercury lamp is reduced at the elevated temperature, the ultra high pressure mercury lamp is frequently renewed and the operating cost is increased. In addition, the operation of the ultra high pressure mercury lamp usually creates safety and pollution issues. Recently, light emitting diodes (LEDs) have gradually replaced the ultra high pressure mercury lamps to be applied in the single-panel projection system. Due to the etendue limitation of the light emitting diode, the utilization efficiency is usually unsatisfied if the angles of the incident light beams are not parallel. Moreover, the ultra high pressure mercury lamps and the light emitting diodes consume much power and thus fail to meet the power-saving requirements.

Conventionally, the single-panel transmissive projection system and the single-panel reflective projection system usually use a color sequential technique. By the color sequential technique, about two third of the brightness is impaired. In addition, a rainbow effect is detrimental to the projecting performance. For increasing the brightness of the single-panel projection system, the watts of the power source need to be increased. In other words, the color sequential technique also fails to meet the power-saving requirements. Moreover, the configurations and signal processing circuitry of the single-panel projection system having the color sequential technique are complicated.

For solving the problems encountered from the color sequential technique, the projection systems disclosed in for example U.S. Pat. Nos. 5,161,042 (to Hamada et al.) and 6,111,618 (to Booth) project the three primary color beams to the pixels in order to maintain the brightness. Although these projection systems are effective to maintain the brightness, the resolution is reduced to about one third of the original value. If the ultra high pressure mercury lamps or the light emitting diodes are used in these projection systems, the above described drawbacks still exist.

Therefore, there is a need of providing an improved projection system to obviate the drawbacks encountered from the prior art.

### SUMMARY OF THE INVENTION

An object of the present invention provides a projection system with minimized volume and low power consumption while maintaining the brightness and enhancing the resolution.

Another object of the present invention provides a projection system having simplified configurations.

In accordance with an aspect of the present invention, there is provided a projection system. The projection system includes a multi-laser beam generator, a beam switching device, a split beam projecting device and a transmissive light valve. The multi-laser beam generator selectively generates a red beam, a green beam and a blue beam. The beam switching device receives the red, green and blue beams that are emitted by the multi-laser beam generator, splits the red, green and blue beams into a plurality of light beams of different angles, and directs the red, green and blue beams of the different angles into a common optical path. The split beam projecting device includes a plurality of micro-lenses. Each micro-lens receives the red, green and blue beams of the different angles that are issued by the beam switching device. The transmissive light valve has a plurality of pixels for receiving the red, green and blue beams that are guided by the split beam projecting device. The red, green and blue beams of the different angles are received by the micro-lenses of the split beam projecting device and guided onto the pixels of the transmissive light valve for imagining on the pixels.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram of a projection system according to the present invention;

FIG. 2A is a schematic perspective view illustrating an exemplary assembly of a split beam projecting device and a transmissive light valve;

FIG. 2B is a schematic perspective view illustrating another exemplary assembly of a split beam projecting device and a transmissive light valve;

FIG. 3 is a schematic view illustrating an assembly of a split beam projecting device and transmissive light valve of FIG. 1 for receiving different beams at different incident angles according to a first preferred embodiment of the present invention;

FIG. 4 is a schematic view illustrating a vibration-type beam splitter part of a mechanical beam switching device for splitting the incident light beams according to the first preferred embodiment of the present invention;

FIG. 5 is a schematic view illustrating a rotation-type beam splitter part of a mechanical beam switching device for splitting the incident light beams according to the first preferred embodiment of the present invention;

FIG. 6 is a schematic view illustrating a beam splitter part of an electronic beam switching device for splitting the incident light beams according to the first preferred embodiment of the present invention;

FIG. 7 is a schematic view illustrating another vibration-type beam splitter part of a mechanical beam switching device for splitting the incident light beams according to the first preferred embodiment of the present invention;

FIG. 8 is a schematic view illustrating another rotation-type beam splitter part of a mechanical beam switching device for splitting the incident light beams according to the first preferred embodiment of the present invention;

FIG. 9 is a schematic view illustrating another beam splitter part of an electronic beam switching device for splitting the incident light beams according to the first preferred embodiment of the present invention;

FIG. 10 is a schematic view illustrating an assembly of a split beam projecting device and transmissive light valve of FIG. 1 for receiving different beams at different incident angles according to a second preferred embodiment of the present invention;

FIG. 11 is a schematic view illustrating a vibration-type beam splitter part of a mechanical beam switching device for splitting the incident light beams according to the second preferred embodiment of the present invention;

FIG. 12 is a schematic view illustrating a rotation-type beam splitter part of a mechanical beam switching device for splitting the incident light beams according to the second preferred embodiment of the present invention;

FIG. 13 is a schematic view illustrating a beam splitter part of an electronic beam switching device for splitting the incident light beams according to the second preferred embodiment of the present invention;

FIG. 14 is a schematic view illustrating an assembly of a split beam projecting device and transmissive light valve of FIG. 1 for receiving different beams at different incident angles according to a third preferred embodiment of the present invention;

FIG. 15 is a schematic view illustrating a first exemplary beam combiner part used in the projection system of the present invention;

FIG. 16 is a schematic view illustrating a second exemplary beam combiner part used in the projection system of the present invention;

FIG. 17 is a schematic view illustrating a third exemplary beam combiner part used in the projection system of the present invention; and

FIG. 18 is a schematic view illustrating a fourth exemplary beam combiner part used in the projection system of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

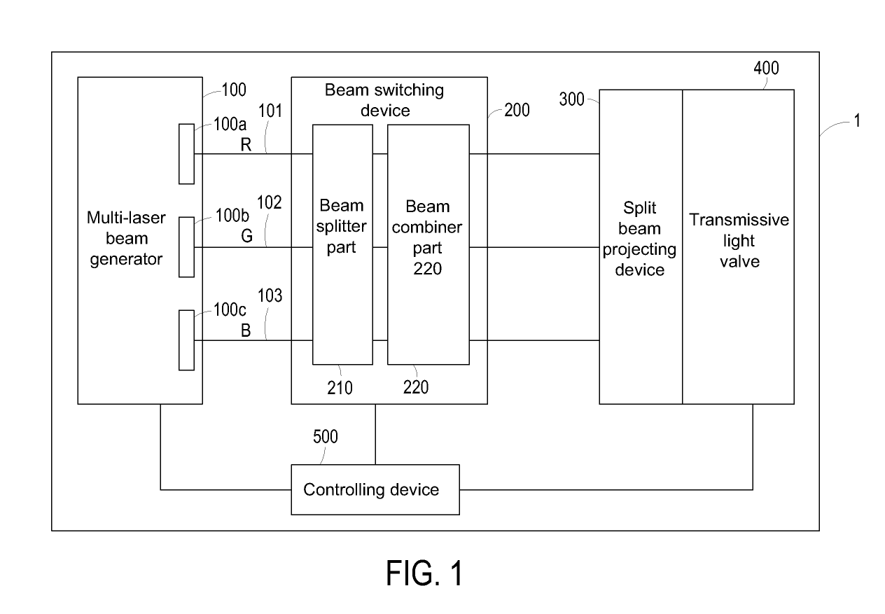

FIG. 1 is a schematic functional block diagram of a projection system according to the present invention. In this embodiment, the projection system 1 is a single-panel projection system. The projection system 1 of FIG. 1 principally comprises a multi-laser beam generator 100, a beam switching device 200, a split beam projecting device 300, a transmissive light valve 400 and a controlling device 500.

The multi-laser beam generator 100 comprises a red laser beam generating unit 100a, a green laser beam generating unit 100b and a blue laser beam generating unit 100c for respectively generating three primary color beams, i.e. a red beam (R) 101, a green beam (G) 102 and a blue beam (B) 103. The red beam, the green beam and the blue beam emitted by the multi-laser beam generator 100 has high directivity and high parallel degree. After receiving the red beam, the green beam and the blue beam emitted by the multi-laser beam generator 100, the beam switching device 200 may split these light beams into a plurality of light beams of different emergent angles and direct the light beams of different emergent angles into a common optical path. The beam switching device 200 principally comprises a beam splitter part 210 and a beam combiner part 220. An example of the beam splitter part 210 is a holographic diffraction element for receiving the red beam, the green beam and the blue beam emitted by the multi-laser beam generator 100 and splitting these light beams into a plurality of light beams of different emergent angles. The light beams of different emergent angles are received by the beam combiner part 220 and combined into the common optical path such that the red beam, the green beam and the blue beam of different emergent angles can be directed to the split beam projecting device 300.

The split beam projecting device 300 comprises a plurality of micro-lens. After receiving the red beam, the green beam and the blue beam of different emergent angles, the micro-lens of the split beam projecting device 300 will guide the red beam, the green beam and the blue beam of different emergent angles into the transmissive light valve 400. The transmissive light valve 400 has a plurality of pixels. The red beam, the green beam and the blue beam of different emergent angles are guided onto the pixels of the transmissive light valve 400 in order to achieve the imaging purpose.

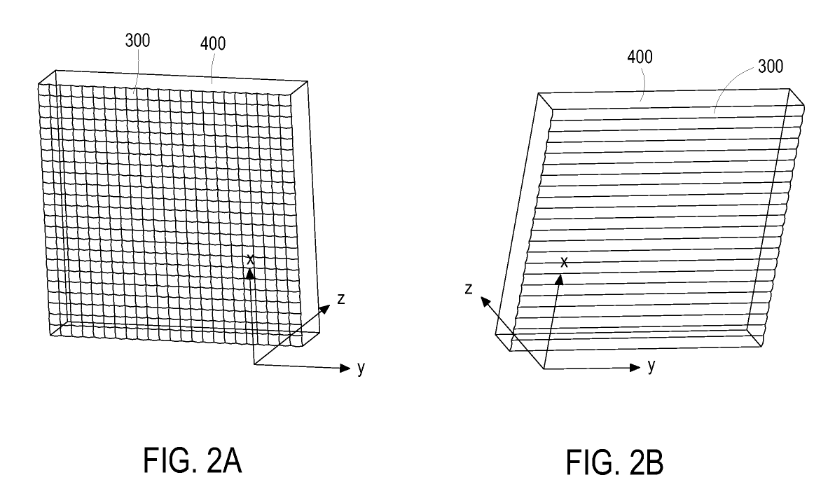

FIG. 2A is a schematic perspective view illustrating an exemplary assembly of a split beam projecting device and a transmissive light valve. FIG. 2B is a schematic perspective view illustrating another exemplary assembly of a split beam projecting device and a transmissive light valve. The split beam projecting device 300 of FIG. 2A is a micro-lens array. The split beam projecting device 300 of FIG. 2B is a micro-cylindrical lens array. Regardless of whether the split beam projecting device 300 is a micro-lens array or a micro-cylindrical lens array, the xy-plane of the split beam projecting device 300 is coincident with the xy-plane of the transmissive light valve 400. The split beam projecting device 300 is composed of a plurality of micro-lenses (as shown in FIG. 2A) or a plurality of micro-cylindrical lenses (as shown in FIG. 2B). Each micro-lens or micro-cylindrical lens is aligned with multiple (e.g. 2, 3, 4, 6 or 9) pixels (not shown) along the x-axis direction of the split beam projecting device 300 and the transmissive light valve 400. Some examples of the split beam projecting device 300 and the transmissive light valve 400 will be illustrated in more details as follows.

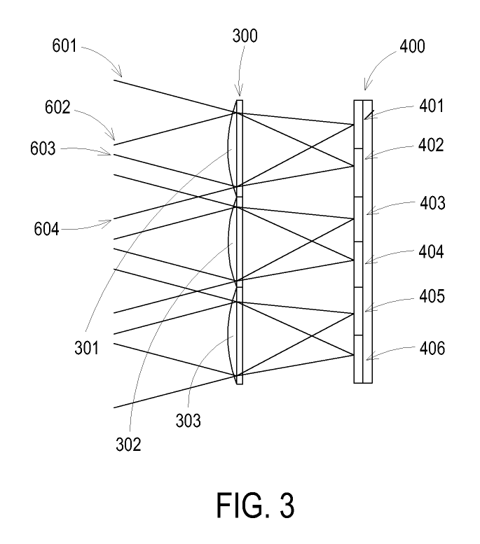

FIG. 3 is a schematic view illustrating an assembly of a split beam projecting device and transmissive light valve of FIG. 1 for receiving different beams at different incident angles according to a first preferred embodiment of the present invention. Please refer to FIGS. 1, 2A and 3. The split beam projecting device 300 is composed of a plurality of micro-lenses (as shown in FIG. 2A) or a plurality of micro-cylindrical lenses (as shown in FIG. 2B). Each micro-lens or micro-cylindrical lens is aligned with two pixels along the x-axis direction of the transmissive light valve 400. For example, the micro-lens 301 is aligned with two pixels 401 and 402; the micro-lens 302 is aligned with two pixels 403 and 404; and the micro-lens 303 is aligned with two pixels 405 and 406. As for the micro-lens 301 of the split beam projecting device 300, four light beams 601, 602, 603 and 604 from the beam switching device 200 are directed to the micro-lens 301 of the split beam projecting device 300 at two different incident angles. As shown in FIG. 3, the light beams 601 and 603 are substantially parallel with each other and have a substantially identical incident angle with respect to the micro-lens 301, so that the light beams 601 and 603 are focused onto the pixel 402 of the transmissive light valve 400 by the micro-lens 301. In addition, the light beams 602 and 604 are substantially parallel with each other and have a substantially identical incident angle with respect to the micro-lens 301, in which the incident angle of the light beams 601 and 603 and the incident angle of the light beams 602 and 604 are different. Consequently, the light beams 602 and 604 are focused onto the pixel 401 of the transmissive light valve 400 by the micro-lens 301. The processes of focusing other light beams onto other pixels of the transmissive light valve 400 by the micro-lenses 302 and 303 are identical to that described for the micro-lenses 301, and are not redundantly described herein. In accordance with a key feature of the present invention, the first set of light beams 601/603 and the second set of light beams 602/604 of different incident angles are switched between different color beams at different time spots by the beam switching device 200.

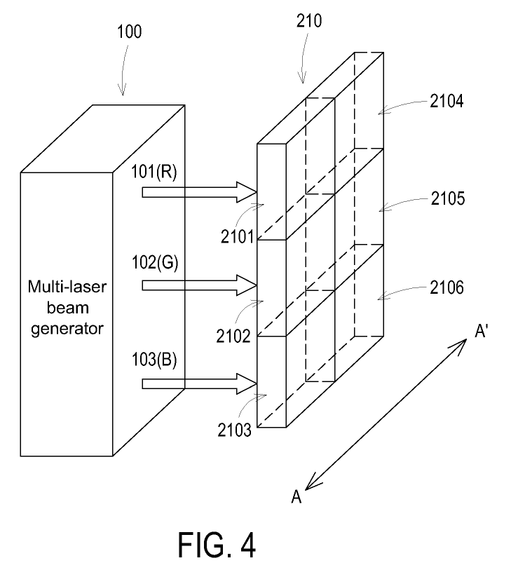

Hereinafter, a first approach of directing light beams by the split beam projecting device 300 and the transmissive light valve 400 of FIG. 3 will be illustrated with reference to FIGS. 4, 5 and 6.

At the time spot t1, the light beams 601 and 603 (e.g. green beams) that are substantially parallel with each other and have an identical incident angle are focused onto the pixel 402 by the micro-lens 301. At this moment, the light beams 602 and 604 (e.g. red beams) that are substantially parallel with each other and have another identical incident angle are focused onto the pixel 401 by the micro-lens 301. The processes of focusing other light beams onto the pixels 403 and 404 by the micro-lens 302 are identical to that described for the micro-lens 301. In addition, the processes of focusing other light beams onto the pixels 405 and 406 by the micro-lenses 303 are identical to that described for the micro-lens 301, and are not redundantly described herein. Next, at the time spot t2, the light beams 601 and 603 (e.g. green beams) that are substantially parallel with each other and have an identical incident angle are focused onto the pixel 402 by the micro-lens 301. At this moment, the light beams 602 and 604 (e.g. blue beams) that are substantially parallel with each other and have another identical incident angle are focused onto the pixel 401 by the micro-lens 301.

Next, at the time spot t3, the light beams 601 and 603 (e.g. red beams) that are substantially parallel with each other and have an identical incident angle are focused onto the pixel 402 by the micro-lens 301. At this moment, the light beams 602 and 604 (e.g. green beams) that are substantially parallel with each other and have another identical incident angle are focused onto the pixel 401 by the micro-lens 301.

Next, at the time spot t4, the light beams 601 and 603 (e.g. blue beams) that are substantially parallel with each other and have an identical incident angle are focused onto the pixel 402 by the micro-lens 301. At this moment, the light beams 602 and 604 (e.g. green beams) that are substantially parallel with each other and have another identical incident angle are focused onto the pixel 401 by the micro-lens 301.

After the time spot t5, the processes as described at t1˜t4 are cyclically repeated according to the table 1-1. By means of time integration, it is found that the red, green and blue beams are all irradiated onto all pixels 401, 402, . . . , and so on. In other words, the brightness and the resolution are not impaired.

TABLE 1-1

Time

| Pixel | t1 | t2 | t3 | t4 | t5 | . . . |
|---|---|---|---|---|---|---|
| 401 | R | B | G | G | R | . . . |
| 402 | G | G | R | B | G | . . . |
| 403 | R | B | G | G | R | . . . |
| 404 | G | G | R | B | G | . . . |
| 405 | R | B | G | G | R | . . . |
| 406 | G | G | R | B | G | . . . |
| . | . | . | . | . | . | . . . |
| . | . | . | . | . | . | |
| . | . | . | . | . | . | |

In the same way, the colors of the light beams received by the pixels 401, 402, . . . at different time spots may be altered in the sequence as shown in the tables 1-2 and 1-3. The processes of directing the light beams listed in the tables 1-2 and 1-3 are identical to those illustrated in the table 1-1, and are not redundantly described herein.

TABLE 1-2

Time

| Pixel | t1 | t2 | t3 | t4 | t5 | . . . |
|---|---|---|---|---|---|---|
| 401 | B | G | R | R | B | . . . |
| 402 | R | R | B | G | R | . . . |
| 403 | B | G | R | R | B | . . . |
| 404 | R | R | B | G | R | . . . |
| 405 | B | G | R | R | B | . . . |
| 406 | R | R | B | G | R | . . . |
| . | . | . | . | . | . | . . . |
| . | . | . | . | . | . | |
| . | . | . | . | . | . | |

TABLE 1-3

Time

| Pixel | t1 | t2 | t3 | t4 | t5 | . . . |
|---|---|---|---|---|---|---|
| 401 | G | R | B | B | G | . . . |
| 402 | B | B | G | R | B | . . . |
| 403 | G | R | B | B | G | . . . |
| 404 | B | B | G | R | B | . . . |
| 405 | G | R | B | B | G | . . . |
| 406 | B | B | G | R | B | . . . |
| . | . | . | . | . | . | . . . |
| . | . | . | . | . | . | |
| . | . | . | . | . | . | |

In this embodiment, the pixel of the transmissive light valve 400 has a side length of about 5˜20 mm. The glass thickness of the transmissive light valve 400 is about 0.4˜0.7 mm. In a case that the transmissive light valve 400 is applied to a projector having a specification of SVGA800*600 or SXGA+1400*1050 and the length of the short side is 3˜21 mm, the distance should be greater than 240˜420 mm in order to split off the incident light beams. Under this circumstance, it is detrimental to minimization. Since the colors of the light beams received by the pixels at different time spots may be altered depending on the split beam projecting device 300, the beam switching device 200 needs to be modified in order to overcome the above drawbacks.

An exemplary beam switching device 200 used in this embodiment includes but is not limited to a mechanical beam switching device or an electronic beam switching device. Regardless of whether a mechanical beam switching device or an electronic beam switching device is adopted, the beam switching device 200 comprises a beam splitter part 210 and a beam combiner part 220. An example of the beam splitter part 210 is a holographic diffraction element for splitting the incident light beams into a plurality of light beams of different emergent angles. The light beams of different emergent angles are received by the beam combiner part 220 and combined into the common optical path such that the red beam, the green beam and the blue beam of different emergent angles can be directed to the split beam projecting device 300. In a case that the beam switching device 200 is a mechanical beam switching device, the beam splitter part 210 can split the incident light beams in a vibration or rotation way. The vibration-type and rotation-type beam splitter parts use holographic diffraction elements at different regions to split light beams of different emergent angles.

FIG. 4 is a schematic view illustrating a vibration-type beam splitter part of a mechanical beam switching device for splitting the incident light beams according to the first preferred embodiment of the present invention. The multi-laser beam generator 100 comprises three laser beam generating units for respectively generating a red beam (R) 101, a green beam (G) 102 and a blue beam (B) 103. The vibration-type beam splitter part 210 has a plurality of beam-splitting regions 2101˜2106. Please refer to FIGS. 1, 3 and 4 and the table 1-1.

At the time spot t1, the green beam (G) 102 is split by the beam-splitting region 2102 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the red beam (R) 101 is split by the beam-splitting region 2101 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the blue beam (B) 103 is shut off by the controlling device 500.

At the time spot t2, the red beam (R) 101 is shut off by the controlling device 500. At this moment, the green beam (G) 102 is split by the beam-splitting region 2102 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the blue beam (B) 103 is split by the beam-splitting region 2103 and propagated through the beam combiner part 220 to generate light beams 602 and 604 that are substantially parallel with each other and have a second identical incident angle. The light beams 602 and 604 are focused onto the pixel 401 by the micro-lens 301.

At the time spot t3, the beam splitter part 210 is moved in the direction denoted as the arrow A under control of the controlling device 500, so that the red beam (R) 101, the green beam (G) 102 and the blue beam (B) 103 can be selectively directed to the beam-splitting regions 2104, 2105, 2106 rather than the beam-splitting regions 2101, 2102, 2103. The red beam (R) 101 is split by the beam-splitting region 2104 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2105 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the blue beam (B) 103 is shut off by the controlling device 500.

At the time spot t4, the red beam (R) 101 is shut off by the controlling device 500. At this moment, the blue beam (B) 103 is split by the beam-splitting region 2106 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2105 and propagated through the beam combiner part 220 to generate light beams 602 and 604 that are substantially parallel with each other and have a second identical incident angle. The light beams 602 and 604 are focused onto the pixel 401 by the micro-lens 301.

Next, the beam splitter part 210 is moved in the direction denoted as the arrow A′ under control of the controlling device 500, so that the red beam (R) 101, the green beam (G) 102 and the blue beam (B) 103 can be selectively directed to the beam-splitting regions 2101, 2102, 2103 rather than the beam-splitting regions 2104, 2105, 2106.

After the time spot t5, the processes as described at t1˜t4 are cyclically repeated according to the table 1-1. In addition, the colors of the light beams received by the pixels at different time spots may be altered depending on the split beam projecting device 300.

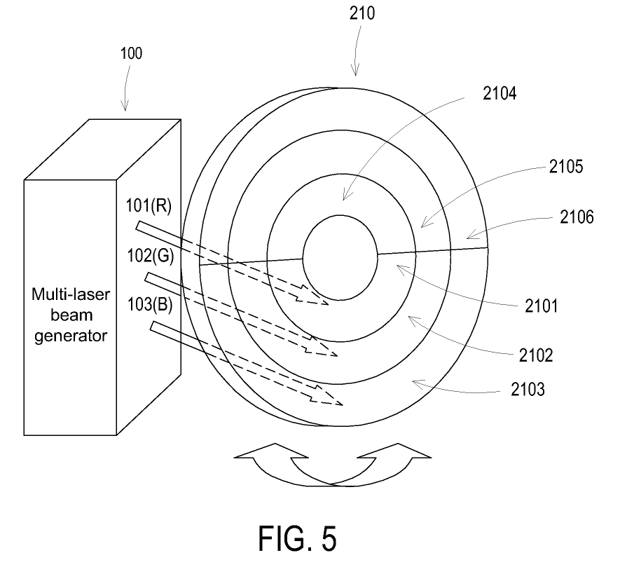

FIG. 5 is a schematic view illustrating a rotation-type beam splitter part of a mechanical beam switching device for splitting the incident light beams according to the first preferred embodiment of the present invention. The multi-laser beam generator 100 comprises three laser beam generating units for respectively generating a red beam (R) 101, a green beam (G) 102 and a blue beam (B) 103. The rotation-type beam splitter part 210 has a plurality of beam-splitting regions 2101˜2106. Please refer to FIGS. 1, 3, and 5 and the table 1-1.

At the time spot t1, the green beam (G) 102 is split by the beam-splitting region 2102 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the red beam (R) 101 is split by the beam-splitting region 2101 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the blue beam (B) 103 is shut off by the controlling device 500.

At the time spot t2, the red beam (R) 101 is shut off by the controlling device 500. At this moment, the green beam (G) 102 is split by the beam-splitting region 2102 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the blue beam (B) 103 is split by the beam-splitting region 2103 and propagated through the beam combiner part 220 to generate light beams 602 and 604 that are substantially parallel with each other and have a second identical incident angle. The light beams 602 and 604 are focused onto the pixel 401 by the micro-lens 301.

At the time spot t3, the beam splitter part 210 is rotated in an anti-clockwise or clockwise direction under control of the controlling device 500, so that the red beam (R) 101, the green beam (G) 102 and the blue beam (B) 103 can be selectively directed to the beam-splitting regions 2104, 2105, 2106 rather than the beam-splitting regions 2101, 2102, 2103. The red beam (R) 101 is split by the beam-splitting region 2104 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2105 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the blue beam (B) 103 is shut off by the controlling device 500.

At the time spot t4, the red beam (R) 101 is shut off by the controlling device 500. At this moment, the blue beam (B) 103 is split by the beam-splitting region 2106 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2105 and propagated through the beam combiner part 220 to generate light beams 602 and 604 that are substantially parallel with each other and have a second identical incident angle. The light beams 602 and 604 are focused onto the pixel 401 by the micro-lens 301.

Next, the beam splitter part 210 is rotated in an anti-clockwise or clockwise direction under control of the controlling device 500, so that the red beam (R) 101, the green beam (G) 102 and the blue beam (B) 103 can be selectively directed to the beam-splitting regions 2101, 2102, 2103 rather than the beam-splitting regions 2104, 2105, 2106.

After the time spot t5, the processes as described at t1˜t4 are cyclically repeated according to the table 1-1. In addition, the colors of the light beams received by the pixels at different time spots may be altered depending on the split beam projecting device 300.

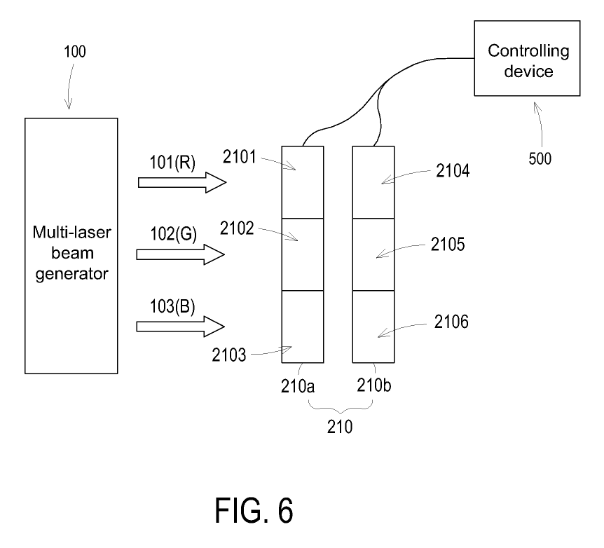

FIG. 6 is a schematic view illustrating a beam splitter part of an electronic beam switching device for splitting the incident light beams according to the first preferred embodiment of the present invention. The multi-laser beam generator 100 comprises three laser beam generating units for respectively generating a red beam (R) 101, a green beam (G) 102 and a blue beam (B) 103. The beam splitter part 210 of the electronic beam switching device 200 has a plurality of beam-splitting regions 2101˜-2106. Please refer to FIGS. 1, 3, and 6 and the table 1-1. The beam-splitting regions 2101, 2102 and 2103 are disposed on a first carrier 210a. The beam-splitting regions 2104, 2105 and 2106 are disposed on a second carrier 210b and respectively aligned with the beam-splitting regions 2101, 2102 and 2103 of the first carrier 210a.

At the time spot t1, the beam-splitting regions 2101, 2102 and 2103 of the beam splitter part 210 are turned on but the beam-splitting regions 2104, 2105 and 2106 of the beam splitter part 210 are turned off under control of the controlling device 500. At this moment, the green beam (G) 102 is split by the beam-splitting region 2102 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the red beam (R) 101 is split by the beam-splitting region 2101 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the blue beam (B) 103 is shut off by the controlling device 500.

At the time spot t2, the red beam (R) 101 is shut off by the controlling device 500. At this moment, the green beam (G) 102 is split by the beam-splitting region 2102 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the blue beam (B) 103 is split by the beam-splitting region 2103 and propagated through the beam combiner part 220 to generate light beams 602 and 604 that are substantially parallel with each other and have a second identical incident angle. The light beams 602 and 604 are focused onto the pixel 401 by the micro-lens 301.

At the time spot t3, the beam-splitting regions 2101, 2102 and 2103 of the beam splitter part 210 are turned off but the beam-splitting regions 2104, 2105 and 2106 of the beam splitter part 210 are turned on under control of the controlling device 500. The red beam (R) 101 is split by the beam-splitting region 2104 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2105 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the blue beam (B) 103 is shut off by the controlling device 500.

At the time spot t4, the red beam (R) 101 is shut off by the controlling device 500. At this moment, the blue beam (B) 103 is split by the beam-splitting region 2106 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2105 and propagated through the beam combiner part 220 to generate light beams 602 and 604 that are substantially parallel with each other and have a second identical incident angle. The light beams 602 and 604 are focused onto the pixel 401 by the micro-lens 301.

Next, the beam-splitting regions 2101, 2102 and 2103 of the beam splitter part 210 are turned on but the beam-splitting regions 2104, 2105 and 2106 of the beam splitter part 210 are turned off under control of the controlling device 500. After the time spot t5, the processes as described at t1˜t4 are cyclically repeated according to the table 1-1. In addition, the colors of the light beams received by the pixels at different time spots may be altered depending on the split beam projecting device 300.

In the same way, the colors of the light beams received by the pixels at different time spots may be altered in the sequence as shown in the tables 1-2 and 1-3. The processes of directing the light beams listed in the tables 1-2 and 1-3 are identical to those illustrated in the table 1-1, and are not redundantly described herein. Moreover, the sequences of generating different color beams can be altered as required.

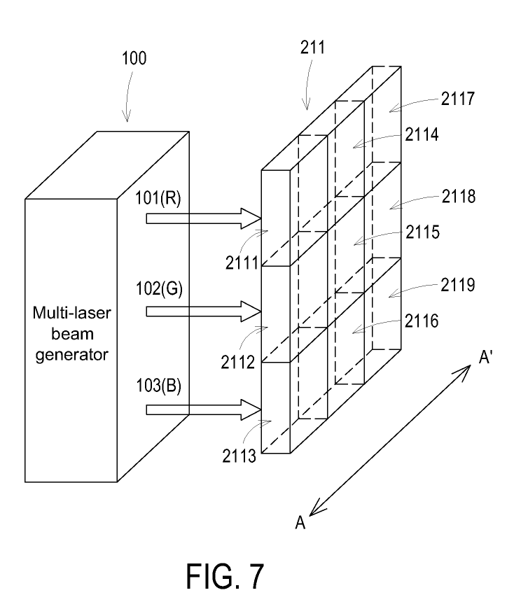

Hereinafter, a second approach of directing light beams by the split beam projecting device 300 and the transmissive light valve 400 of FIGS. 1 and 3 will be illustrated with reference to FIGS. 7, 8 and 9.

At the time spot t1, the light beams 601 and 603 (e.g. green beams) that are substantially parallel with each other and have an identical incident angle are focused onto the pixel 402 by the micro-lens 301. At this moment, the light beams 602 and 604 (e.g. red beams) that are substantially parallel with each other and have another identical incident angle are focused onto the pixel 401 by the micro-lens 301. The processes of focusing other light beams onto the pixels 403 and 404 by the micro-lens 302 are identical to that described for the micro-lens 301. In addition, the processes of focusing other light beams onto the pixels 405 and 406 by the micro-lenses 303 are identical to that described for the micro-lens 301, and are not redundantly described herein.

Next, at the time spot t2, the light beams 601 and 603 (e.g. blue beams) that are substantially parallel with each other and have an identical incident angle are focused onto the pixel 402 by the micro-lens 301. At this moment, the light beams 602 and 604 (e.g. green beams) that are substantially parallel with each other and have another identical incident angle are focused onto the pixel 401 by the micro-lens 301.

Next, at the time spot t3, the light beams 601 and 603 (e.g. red beams) that are substantially parallel with each other and have an identical incident angle are focused onto the pixel 402 by the micro-lens 301. At this moment, the light beams 602 and 604 (e.g. blue beams) that are substantially parallel with each other and have another identical incident angle are focused onto the pixel 401 by the micro-lens 301.

Next, at the time spot t4, the light beams 601 and 603 (e.g. red beams) that are substantially parallel with each other and have an identical incident angle are focused onto the pixel 402 by the micro-lens 301. At this moment, the light beams 602 and 604 (e.g. green beams) that are substantially parallel with each other and have another identical incident angle are focused onto the pixel 401 by the micro-lens 301.

Next, at the time spot t5, the light beams 601 and 603 (e.g. blue beams) that are substantially parallel with each other and have an identical incident angle are focused onto the pixel 402 by the micro-lens 301. At this moment, the light beams 602 and 604 (e.g. red beams) that are substantially parallel with each other and have another identical incident angle are focused onto the pixel 401 by the micro-lens 301.

Next, at the time spot t6, the light beams 601 and 603 (e.g. green beams) that are substantially parallel with each other and have an identical incident angle are focused onto the pixel 402 by the micro-lens 301. At this moment, the light beams 602 and 604 (e.g. blue beams) that are substantially parallel with each other and have another identical incident angle are focused onto the pixel 401 by the micro-lens 301.

After the time spot t7, the processes as described at t1˜t6 are cyclically repeated according to the table 1-4. By means of time integration, it is found that the red, green and blue beams are all irradiated onto all pixels 401, 402, . . . , and so on. In other words, the brightness and the resolution are not impaired.

TABLE 1-4

Time

| Pixel | t1 | t2 | t3 | t4 | t5 | t6 | t7 | . . . |
|---|---|---|---|---|---|---|---|---|
| 401 | R | G | B | G | R | B | R | . . . |
| 402 | G | B | R | R | B | G | G | . . . |
| 403 | R | G | B | G | R | B | R | . . . |
| 404 | G | B | R | R | B | G | G | . . . |
| 405 | R | G | B | G | R | B | R | . . . |
| 406 | G | B | R | R | B | G | G | . . . |
| . | . | . | . | . | . | . | . | . . . |
| . | . | . | . | . | . | . | . | |
| . | . | . | . | . | . | . | . | |

In the same way, the colors of the light beams received by the pixels 401, 402, . . . at different time spots may be altered in the sequence as shown in the table 1-5. The processes of directing the light beams listed in the table 1-5 are identical to those illustrated in the table 1-4, and are not redundantly described herein.

TABLE 1-5

Time

| Pixel | t1 | t2 | t3 | t4 | t5 | t6 | t7 | . . . |
|---|---|---|---|---|---|---|---|---|
| 401 | R | G | B | R | G | B | R | . . . |
| 402 | G | B | R | B | R | G | G | . . . |
| 403 | R | G | B | R | G | B | R | . . . |
| 404 | G | B | R | B | R | G | G | . . . |
| 405 | R | G | B | R | G | B | R | . . . |
| 406 | G | B | R | B | R | G | G | . . . |
| . | . | . | . | . | . | . | . | . . . |
| . | . | . | . | . | . | . | . | |
| . | . | . | . | . | . | . | . | |

In the same way, the colors of the light beams received by the pixels 401, 402, . . . at different time spots may be altered as required. The processes of directing the light beams are identical to those illustrated in the tables 1-4 and 1-5, and are not redundantly described herein.

An exemplary beam switching device 200 used in this embodiment includes but is not limited to a mechanical beam switching device or an electronic beam switching device. Regardless of whether a mechanical beam switching device or an electronic beam switching device is adopted, the beam switching device 200 comprises a beam splitter part 210 and a beam combiner part 220. An example of the beam splitter part 210 is a holographic diffraction element for splitting the incident light beams into a plurality of light beams of different emergent angles. The light beams of different emergent angles are received by the beam combiner part 220 and combined into the common optical path such that the red beam, the green beam and the blue beam of different emergent angles can be directed to the split beam projecting device 300. In a case that the beam switching device 200 is a mechanical beam switching device, the beam splitter part 210 can split the incident light beams in a vibration or rotation way. The vibration-type and rotation-type beam splitter parts use holographic diffraction elements at different regions to split light beams of different emergent angles.

FIG. 7 is a schematic view illustrating another vibration-type beam splitter part of a mechanical beam switching device for splitting the incident light beams according to the first preferred embodiment of the present invention. The multi-laser beam generator 100 comprises three laser beam generating units for respectively generating a red beam (R) 101, a green beam (G) 102 and a blue beam (B) 103. The vibration-type beam splitter part 211 has a plurality of beam-splitting regions 2111˜2119. Please refer to FIGS. 1, 3 and 7 and the table 1-4.

At the time spot t1, the green beam (G) 102 is split by the beam-splitting region 2112 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the red beam (R) 101 is split by the beam-splitting region 2111 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the blue beam (B) 103 is shut off by the controlling device 500.

At the time spot t2, the beam splitter part 211 is moved in the direction denoted as the arrow A under control of the controlling device 500, so that the red beam (R) 101, the green beam (G) 102 and the blue beam (B) 103 are switched to be selectively directed to the beam-splitting regions 2114, 2115, 2116 from the beam-splitting regions 2111, 2112, 2113. The red beam (R) 101 is shut off by the controlling device 500. At this moment, the blue beam (B) 103 is split by the beam-splitting region 2116 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2115 and propagated through the beam combiner part 220 to generate light beams 602 and 604 that are substantially parallel with each other and have a second identical incident angle. The light beams 602 and 604 are focused onto the pixel 401 by the micro-lens 301.

At the time spot t3, the beam splitter part 211 is continuously moved in the direction denoted as the arrow A under control of the controlling device 500, so that the red beam (R) 101, the green beam (G) 102 and the blue beam (B) 103 are switched to be selectively directed to the beam-splitting regions 2117, 2118, 2119 from the beam-splitting regions 2114, 2115, 2116. The red beam (R) 101 is split by the beam-splitting region 2117 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the blue beam (B) 103 is split by the beam-splitting region 2119 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the green beam (G) 102 is shut off by the controlling device 500.

At the time spot t4, the red beam (R) 101 is split by the beam-splitting region 2117 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2118 and propagated through the beam combiner part 220 to generate light beams 602 and 604 that are substantially parallel with each other and have a second identical incident angle. The light beams 602 and 604 are focused onto the pixel 401 by the micro-lens 301.

At the time spot t5, the beam splitter part 211 is moved in the direction denoted as the arrow A′ under control of the controlling device 500, so that the red beam (R) 101, the green beam (G) 102 and the blue beam (B) 103 are switched to be selectively directed to the beam-splitting regions 2114, 2115, 2116 from the beam-splitting regions 2117, 2118, 2119. The blue beam (B) 103 is split by the beam-splitting region 2116 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the red beam (R) 101 is split by the beam-splitting region 2114 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the green beam (G) 102 is shut off by the controlling device 500.

At the time spot t6, the beam splitter part 211 is continuously moved in the direction denoted as the arrow A′ under control of the controlling device 500, so that the red beam (R) 101, the green beam (G) 102 and the blue beam (B) 103 are switched to be selectively directed to the beam-splitting regions 2111, 2112, 2113 from the beam-splitting regions 2114, 2115, 2116. The red beam (R) 101 is shut off by the controlling device 500. At this moment, the green beam (G) 102 is split by the beam-splitting region 2112 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the blue beam (B) 103 is split by the beam-splitting region 2113 and propagated through the beam combiner part 220 to generate light beams 602 and 604 that are substantially parallel with each other and have a second identical incident angle. The light beams 602 and 604 are focused onto the pixel 401 by the micro-lens 301.

After the time spot t7, the beam splitter part 211 is moved under control of the controlling device 500 and the processes as described at t1˜t6 are cyclically repeated according to the table 1-4. In addition, the colors of the light beams received by the pixels at different time spots may be altered depending on the split beam projecting device 300.

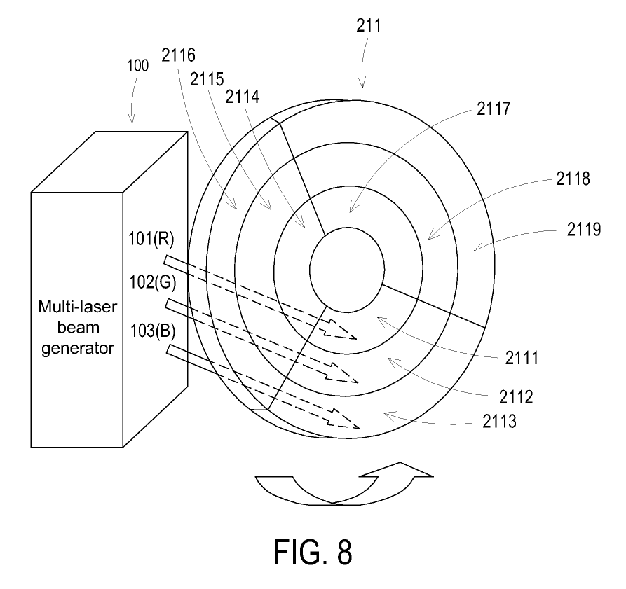

FIG. 8 is a schematic view illustrating another rotation-type beam splitter part of a mechanical beam switching device for splitting the incident light beams according to the first preferred embodiment of the present invention. The multi-laser beam generator 100 comprises three laser beam generating units for respectively generating a red beam (R) 101, a green beam (G) 102 and a blue beam (B) 103. The rotation-type beam splitter part 211 has a plurality of beam-splitting regions 2111˜2119. Please refer to FIGS. 1, 3, and 8 and the table 1-5.

At the time spot t1, the green beam (G) 102 is split by the beam-splitting region 2112 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the red beam (R) 101 is split by the beam-splitting region 2111 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the blue beam (B) 103 is shut off by the controlling device 500.

At the time spot t2, the beam splitter part 211 is rotated in an anti-clockwise direction under control of the controlling device 500, so that the red beam (R) 101, the green beam (G) 102 and the blue beam (B) 103 are switched to be selectively directed to the beam-splitting regions 2114, 2115, 2116 from the beam-splitting regions 2111, 2112, 2113. The red beam (R) 101 is shut off by the controlling device 500. At this moment, the blue beam (B) 103 is split by the beam-splitting region 2116 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2115 and propagated through the beam combiner part 220 to generate light beams 602 and 604 that are substantially parallel with each other and have a second identical incident angle. The light beams 602 and 604 are focused onto the pixel 401 by the micro-lens 301.

At the time spot t3, the beam splitter part 211 is continuously rotated in an anti-clockwise direction under control of the controlling device 500, so that the red beam (R) 101, the green beam (G) 102 and the blue beam (B) 103 are switched to be selectively directed to the beam-splitting regions 2117, 2118, 2119 from the beam-splitting regions 2114, 2115, 2116. The red beam (R) 101 is split by the beam-splitting region 2117 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the blue beam (B) 103 is split by the beam-splitting region 2119 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the green beam (G) 102 is shut off by the controlling device 500.

At the time spot t4, the beam splitter part 211 is continuously rotated in an anti-clockwise direction under control of the controlling device 500, so that the red beam (R) 101, the green beam (G) 102 and the blue beam (B) 103 are switched to be selectively directed to the beam-splitting regions 2111, 2112, 2113 from the beam-splitting regions 2117, 2118, 2119. The green beam (G) 102 is shut off by the controlling device 500. At this moment, the blue beam (B) 103 is split by the beam-splitting region 2113 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the red beam (R) 101 is split by the beam-splitting region 2111 and propagated through the beam combiner part 220 to generate light beams 602 and 604 that are substantially parallel with each other and have a second identical incident angle. The light beams 602 and 604 are focused onto the pixel 401 by the micro-lens 301.

At the time spot t5, the beam splitter part 211 is continuously rotated in an anti-clockwise direction under control of the controlling device 500, so that the red beam (R) 101, the green beam (G) 102 and the blue beam (B) 103 are switched to be selectively directed to the beam-splitting regions 2114, 2115, 2116 from the beam-splitting regions 2111, 2112, 2113. The red beam (R) 101 is split by the beam-splitting region 2114 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2115 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the blue beam (B) 103 is shut off by the controlling device 500.

At the time spot t6, the beam splitter part 211 is continuously rotated in an anti-clockwise direction under control of the controlling device 500, so that the red beam (R) 101, the green beam (G) 102 and the blue beam (B) 103 are switched to be selectively directed to the beam-splitting regions 2117, 2118, 2119 from the beam-splitting regions 2114, 2115, 2116. The red beam (R) 101 is shut off by the controlling device 500. At this moment, the green beam (G) 102 is split by the beam-splitting region 2118 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the blue beam (B) 103 is split by the beam-splitting region 2119 and propagated through the beam combiner part 220 to generate light beams 602 and 604 that are substantially parallel with each other and have a second identical incident angle. The light beams 602 and 604 are focused onto the pixel 401 by the micro-lens 301.

At the time spot t7, the beam splitter part 211 is continuously rotated in an anti-clockwise direction under control of the controlling device 500, so that the red beam (R) 101, the green beam (G) 102 and the blue beam (B) 103 are switched to be selectively directed to the beam-splitting regions 2111, 2112, 2113 from the beam-splitting regions 2117, 2118, 2119. The processes as described at t1˜t6 are cyclically repeated according to the table 1-5. In addition, the colors of the light beams received by the pixels at different time spots may be altered depending on the split beam projecting device 300.

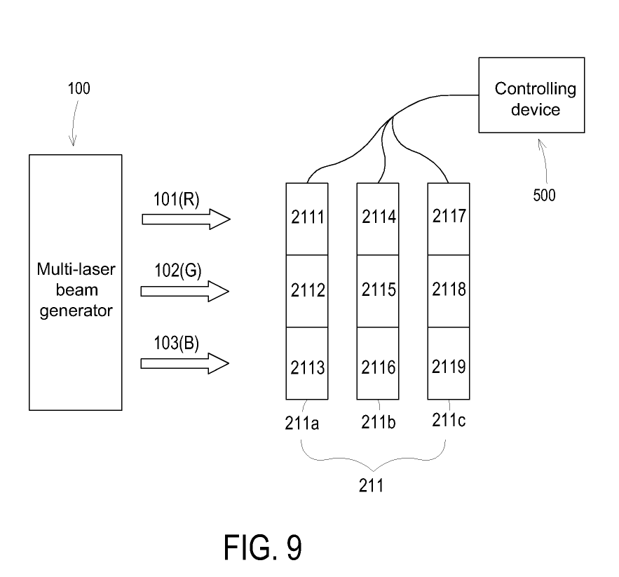

FIG. 9 is a schematic view illustrating another beam splitter part of an electronic beam switching device for splitting the incident light beams according to the first preferred embodiment of the present invention. The multi-laser beam generator 100 comprises three laser beam generating units for respectively generating a red beam (R) 101, a green beam (G) 102 and a blue beam (B) 103. The beam splitter part 211 of the electronic beam switching device 200 has a plurality of beam-splitting regions 2111˜2119. The beam-splitting regions 2111, 2112 and 2113 are disposed on a first carrier 211a. The beam-splitting regions 2114, 2115 and 2116 are disposed on a second carrier 211b and respectively aligned with the beam-splitting regions 2111, 2112 and 2113 of the first carrier 211a. The beam-splitting regions 2117, 2118 and 2119 are disposed on a third carrier 211c and respectively aligned with the beam-splitting regions 2114, 2115 and 2116 of the second carrier 211b. Please refer to FIGS. 1, 3, and 9 and the table 1-4.

At the time spot t1, the beam-splitting regions 2111, 2112 and 2113 of the beam splitter part 211 are turned on but the beam-splitting regions 2114, 2115, 2116, 2117, 2118 and 2119 of the beam splitter part 211 are turned off under control of the controlling device 500. At this moment, the green beam (G) 102 is split by the beam-splitting region 2112 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the red beam (R) 101 is split by the beam-splitting region 2111 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the blue beam (B) 103 is shut off by the controlling device 500.

At the time spot t2, the beam-splitting regions 2114, 2115 and 2116 of the beam splitter part 211 are turned on but the beam-splitting regions 2111, 2112, 2113, 2117, 2118 and 2119 of the beam splitter part 211 are turned off under control of the controlling device 500. The red beam (R) 101 is shut off by the controlling device 500. At this moment, the blue beam (B) 103 is split by the beam-splitting region 2116 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the green beam (G) 102 is split by the beam-splitting region 2115 and propagated through the beam combiner part 220 to generate light beams 602 and 604 that are substantially parallel with each other and have a second identical incident angle. The light beams 602 and 604 are focused onto the pixel 401 by the micro-lens 301.

At the time spot t3, the beam-splitting regions 2117, 2118 and 2119 of the beam splitter part 211 are turned on but the beam-splitting regions 2111, 2112, 2113, 2114, 2115 and 2116 of the beam splitter part 211 are turned off under control of the controlling device 500. The red beam (R) 101 is split by the beam-splitting region 2117 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the blue beam (B) 103 is split by the beam-splitting region 2119 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the green beam (G) 102 is shut off by the controlling device 500.

At the time spot t4, the blue beam (B) 103 is shut off by the controlling device 500. At this moment, the red beam (R) 101 is split by the beam-splitting region 2117 and propagated through the beam combiner part 220 to generate light beams 601 and 603 that are substantially parallel with each other and have a first identical incident angle. At this moment, the green beam (G) 102 is split by the beam-splitting region 2118 and propagated through the beam combiner part 220 to generate light beams 602 and 604 that are substantially parallel with each other and have a second identical incident angle. The light beams 602 and 604 are focused onto the pixel 401 by the micro-lens 301.

At the time spot t5, the beam-splitting regions 2114, 2115 and 2116 of the beam splitter part 211 are turned on but the beam-splitting regions 2111, 2112, 2113, 2117, 2118 and 2119 of the beam splitter part 211 are turned off under control of the controlling device 500. The blue beam (B) 103 is split by the beam-splitting region 2116 and propagated through the beam combiner part 220 to generate light beams 601 and 603 that are substantially parallel with each other and have a first identical incident angle. The light beams 601 and 603 are focused onto the pixel 402 by the micro-lens 301. At this moment, the red beam (R) 101 is split by the beam-splitting region 2114 and propagated through the beam combiner part 220 to generate light beams 602 and 604 that are substantially parallel with each other and have a second identical incident angle. The light beams 602 and 604 are focused onto the pixel 401 by the micro-lens 301. At this moment, the green beam (G) 102 is shut off by the controlling device 500.

At the time spot t6, the beam-splitting regions 2111, 2112 and 2113 of the beam splitter part 211 are turned on but the beam-splitting regions 2114, 2115, 2116, 2117, 2118 and 2119 of the beam splitter part 211 are turned off under control of the controlling device 500. At this moment, the green beam (G) 102 is split by the beam-splitting region 2112 and propagated through the beam combiner part 220 to generate light beams 601 and 603 that are substantially parallel with each other and have a first identical incident angle. The light beams 601 and 603 are focused onto the pixel 402 by the micro-lens 301. The red beam (R) 101 is shut off by the controlling device 500. At this moment, the blue beam (B) 103 is split by the beam-splitting region 2113 and propagated through the beam combiner part 220 to generate light beams 602 and 604 that are substantially parallel with each other and have a second identical incident angle. The light beams 602 and 604 are focused onto the pixel 401 by the micro-lens 301.

After the time spot t7, the beam-splitting regions of the beam splitter part 211 are selectively turned on or turned off and the processes as described at t1˜t6 are cyclically repeated according to the table 1-4. In addition, the colors of the light beams received by the pixels at different time spots may be altered depending on the split beam projecting device 300.

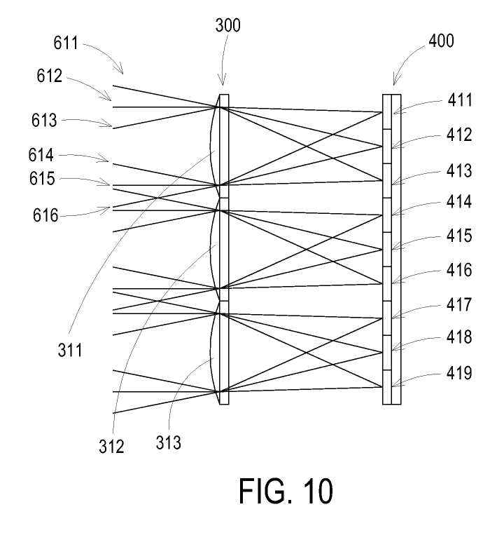

FIG. 10 is a schematic view illustrating an assembly of a split beam projecting device and transmissive light valve of FIG. 1 for receiving different beams at different incident angles according to a second preferred embodiment of the present invention. Please refer to FIGS. 1, 2A and 10. The split beam projecting device 300 is composed of a plurality of micro-lenses (as shown in FIG. 2A) or a plurality of micro-cylindrical lenses (as shown in FIG. 2B). Each micro-lens or micro-cylindrical lens is aligned with three pixels along the x-axis direction of the transmissive light valve 400. For example, the micro-lens 311 is aligned with three pixels 411, 412 and 413; the micro-lens 312 is aligned with three pixels 414, 415 and 416; and the micro-lens 313 is aligned with three pixels 417, 418 and 419. As for the micro-lens 311 of the split beam projecting device 300, six light beams 611, 612, 613, 614, 615 and 616 from the beam switching device 200 are directed to the micro-lens 311 of the split beam projecting device 300 at three different incident angles. As shown in FIG. 10, the light beams 611 and 614 are substantially parallel with each other and have a substantially identical incident angle with respect to the micro-lens 311, so that the light beams 611 and 614 are focused onto the pixel 413 of the transmissive light valve 400 by the micro-lens 311. In addition, the light beams 612 and 615 are substantially parallel with each other and have a substantially identical incident angle with respect to the micro-lens 311, in which the incident angle of the light beams 612 and 615 and the incident angle of the light beams 611 and 614 are different. Consequently, the light beams 612 and 615 are focused onto the pixel 412 of the transmissive light valve 400 by the micro-lens 311. In addition, the light beams 613 and 616 are substantially parallel with each other and have a substantially identical incident angle with respect to the micro-lens 311, in which the incident angle of the light beams 613 and 616, the incident angle of the light beams 611 and 614 and the incident angle of the light beams 612 and 615 are different. Consequently, the light beams 613 and 616 are focused onto the pixel 411 of the transmissive light valve 400 by the micro-lens 311. The processes of focusing other light beams onto other pixels of the transmissive light valve 400 by the micro-lenses 312 and 313 are identical to that described for the micro-lens 311, and are not redundantly described herein. In accordance with a key feature of the present invention, the first set of light beams 611/614, the second set of light beams 612/615 and the third set of light beams 613/616 of different incident angles are switched between different color beams at different time spots by the beam switching device 200.

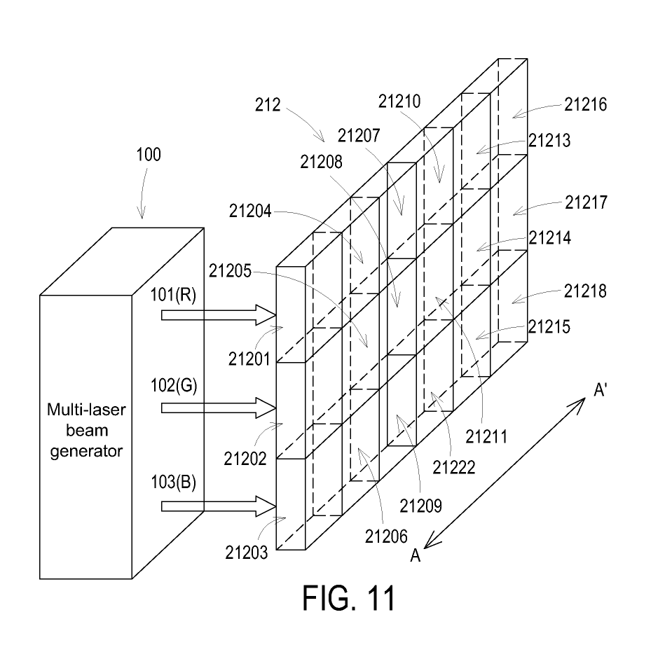

Hereinafter, an approach of directing light beams by the split beam projecting device 300 and the transmissive light valve 400 of FIG. 10 will be illustrated with reference to FIGS. 11, 12 and 13.

At the time spot t1, the light beams 611 and 614 (e.g. blue beams) that are substantially parallel with each other and have a first identical incident angle are focused onto the pixel 413 by the micro-lens 311. At this moment, the light beams 612 and 615 (e.g. green beams) that are substantially parallel with each other and have a second identical incident angle are focused onto the pixel 412 by the micro-lens 311. At this moment, the light beams 613 and 616 (e.g. red beams) that are substantially parallel with each other and have a third identical incident angle are focused onto the pixel 411 by the micro-lens 311. The processes of focusing other light beams onto the pixels 414, 415 and 416 by the micro-lens 312 are identical to that described for the micro-lens 311. In addition, the processes of focusing other light beams onto the pixels 417, 418 and 419 by the micro-lenses 313 are identical to that described for the micro-lens 311, and are not redundantly described herein.

Next, at the time spot t2, the light beams 611 and 614 (e.g. red beams) that are substantially parallel with each other and have the first identical incident angle are focused onto the pixel 413 by the micro-lens 311. At this moment, the light beams 612 and 615 (e.g. blue beams) that are substantially parallel with each other and have the second identical incident angle are focused onto the pixel 412 by the micro-lens 311. At this moment, the light beams 613 and 616 (e.g. green beams) that are substantially parallel with each other and have the third identical incident angle are focused onto the pixel 411 by the micro-lens 311.

Next, at the time spot t3, the light beams 611 and 614 (e.g. green beams) that are substantially parallel with each other and have the first identical incident angle are focused onto the pixel 413 by the micro-lens 311. At this moment, the light beams 612 and 615 (e.g. red beams) that are substantially parallel with each other and have the second identical incident angle are focused onto the pixel 412 by the micro-lens 311. At this moment, the light beams 613 and 616 (e.g. blue beams) that are substantially parallel with each other and have the third identical incident angle are focused onto the pixel 411 by the micro-lens 311.

Next, at the time spot t4, the light beams 611 and 614 (e.g. red beams) that are substantially parallel with each other and have the first identical incident angle are focused onto the pixel 413 by the micro-lens 311. At this moment, the light beams 612 and 615 (e.g. green beams) that are substantially parallel with each other and have the second identical incident angle are focused onto the pixel 412 by the micro-lens 311. At this moment, the light beams 613 and 616 (e.g. blue beams) that are substantially parallel with each other and have the third identical incident angle are focused onto the pixel 411 by the micro-lens 311.

Next, at the time spot t5, the light beams 611 and 614 (e.g. blue beams) that are substantially parallel with each other and have the first identical incident angle are focused onto the pixel 413 by the micro-lens 311. At this moment, the light beams 612 and 615 (e.g. red beams) that are substantially parallel with each other and have the second identical incident angle are focused onto the pixel 412 by the micro-lens 311. At this moment, the light beams 613 and 616 (e.g. green beams) that are substantially parallel with each other and have the third identical incident angle are focused onto the pixel 411 by the micro-lens 311.

Next, at the time spot t6, the light beams 611 and 614 (e.g. green beams) that are substantially parallel with each other and have the first identical incident angle are focused onto the pixel 413 by the micro-lens 311. At this moment, the light beams 612 and 615 (e.g. blue beams) that are substantially parallel with each other and have the second identical incident angle are focused onto the pixel 412 by the micro-lens 311. At this moment, the light beams 613 and 616 (e.g. red beams) that are substantially parallel with each other and have the third identical incident angle are focused onto the pixel 411 by the micro-lens 311.

Next, at the time spot t7, the process as described at the time spot t6 is performed. At the time spot t8, the process as described at the time spot t5 is performed. At the time spot t9, the process as described at the time spot t4 is performed. At the time spot t10, the process as described at the time spot t3 is performed. At the time spot t11, the process as described at the time spot t2 is performed. At the time spot t12, the process as described at the time spot t1 is performed.

After the time spot t13, the processes as described at t1˜t12 are cyclically repeated according to the table 2-1. By means of time integration, it is found that the red, green and blue beams are all irradiated onto all pixels 411, 412, 413, . . . , and so on. In other words, the brightness and the resolution are not impaired.

In the same way, the colors of the light beams received by the pixels 411, 412, 413, . . . at different time spots may be altered according to the sequence as shown in the table 2-1 while changing the colors of the light beams in a cycle of t1˜t12.

TABLE 2-1

| | Time | | | | | | | | | | | | |
|---|---|---|---|---|---|---|---|---|---|---|---|---|---|
| Pixel | t1 | t2 | t3 | t4 | t5 | t6 | t7 | t8 | t9 | t10 | t11 | t12 | . . . |
| 411 | R | G | B | B | G | R | R | G | B | B | G | R | . . . |
| 412 | G | B | R | G | R | B | B | R | G | R | B | G | . . . |
| 413 | B | R | G | R | B | G | G | B | R | G | R | B | . . . |
| 414 | R | G | B | B | G | R | R | G | B | B | G | R | . . . |
| 415 | G | B | R | G | R | B | B | R | G | R | G | G | . . . |
| 416 | B | R | G | R | B | G | G | B | R | G | R | B | . . . |
| . | . | . | . | . | . | . | . | . | . | . | . | . | . . . |
| . | . | . | . | . | . | . | . | . | . | . | . | . | |
| . | . | . | . | . | . | . | . | . | . | . | . | . | |

In the same way, the colors of the light beams received by the pixels 411, 412, 413, . . . at different time spots may be altered according to the sequence as shown in the table 2-2 while changing the colors of the light beams in a cycle of t1˜t6.

The processes of directing the light beams listed in the table 2-2 are identical to those illustrated in the table 2-1, and are not redundantly described herein.

TABLE 2-2

| | Time | | | | | | | | | | | | |
|---|---|---|---|---|---|---|---|---|---|---|---|---|---|
| Pixel | t1 | t2 | t3 | t4 | t5 | t6 | t7 | t8 | t9 | t10 | t11 | t12 | . . . |
| 411 | R | G | B | B | G | R | R | G | B | B | G | R | . . . |
| 412 | G | B | R | G | R | B | G | B | R | G | R | B | . . . |
| 413 | B | R | G | R | B | G | B | R | G | R | B | G | . . . |
| 414 | R | G | B | B | G | R | R | G | B | B | G | R | . . . |
| 415 | G | B | R | G | R | B | G | B | R | G | R | B | . . . |
| 416 | B | R | G | R | B | G | B | R | G | R | B | G | . . . |
| . | . | . | . | . | . | . | . | . | . | . | . | . | . . . |
| . | . | . | . | . | . | . | . | . | . | . | . | . | |
| . | . | . | . | . | . | . | . | . | . | . | . | . | |

In the same way, the colors of the light beams received by the pixels 411, 412, 413, . . . at different time spots may be altered in the sequence as shown in the tables 2-1 and 2-1.

In this embodiment, the pixel of the transmissive light valve 400 has a side length of about 5˜20 mm. The glass thickness of the transmissive light valve 400 is about 0.4˜0.7 mm. In a case that the transmissive light valve 400 is applied to a projector having a specification of SVGA800*600 or SXGA+1400*1050 and the length of the short side is 3˜21 mm, the distance should be greater than 240˜420 mm in order to split off the incident light beams. Under this circumstance, it is detrimental to minimization. Since the colors of the light beams received by the pixels at different time spots may be altered depending on the split beam projecting device 300, the beam switching device 200 needs to be modified in order to overcome the above drawbacks.

An exemplary beam switching device 200 used in this embodiment includes but is not limited to a mechanical beam switching device or an electronic beam switching device. Regardless of whether a mechanical beam switching device or an electronic beam switching device is adopted, the beam switching device 200 comprises a beam splitter part 210 and a beam combiner part 220. An example of the beam splitter part 210 is a holographic diffraction element for splitting the incident light beams into a plurality of light beams of different emergent angles. The light beams of different emergent angles are received by the beam combiner part 220 and combined into the common optical path such that the red beam, the green beam and the blue beam of different emergent angles can be directed to the split beam projecting device 300. In a case that the beam switching device 200 is a mechanical beam switching device, the beam splitter part 210 can split the incident light beams in a vibration or rotation way. The vibration-type and rotation-type beam splitter parts use holographic diffraction elements at different regions to split light beams of different emergent angles.

FIG. 11 is a schematic view illustrating a vibration-type beam splitter part of a mechanical beam switching device for splitting the incident light beams according to the second preferred embodiment of the present invention. The multi-laser beam generator 100 comprises three laser beam generating units for respectively generating a red beam (R) 101, a green beam (G) 102 and a blue beam (B) 103. The vibration-type beam splitter part 212 has a plurality of beam-splitting regions 21201˜21218. Please refer to FIGS. 1, 10 and 11 and the table 2-1.

At the time spot t1, the blue beam (B) 103 is split by the beam-splitting region 21203 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the green beam (G) 102 is split by the beam-splitting region 21202 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the red beam (R) 101 is split by the beam-splitting region 21201 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t2, the beam splitter part 212 is moved in the direction denoted as the arrow A under control of the controlling device 500, so that the red beam (R) 101, the green beam (G) 102 and the blue beam (B) 103 are switched to be selectively directed to the beam-splitting regions 21204, 21205, 21206 from the beam-splitting regions 21201, 21202, 21203. At this moment, the red beam (R) 101 is split by the beam-splitting region 21204 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the blue beam (B) 103 is split by the beam-splitting region 21206 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the green beam (G) 102 is split by the beam-splitting region 21205 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t3, the beam splitter part 212 is continuously moved in the direction denoted as the arrow A under control of the controlling device 500, so that the red beam (R) 101, the green beam (G) 102 and the blue beam (B) 103 are switched to be selectively directed to the beam-splitting regions 21207, 21208, 21209 from the beam-splitting regions 21204, 21205, 21206. At this moment, the green beam (G) 102 is split by the beam-splitting region 21208 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the red beam (R) 101 is split by the beam-splitting region 21207 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the blue beam (B) 103 is split by the beam-splitting region 21209 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t4, the beam splitter part 212 is continuously moved in the direction denoted as the arrow A under control of the controlling device 500, so that the red beam (R) 101, the green beam (G) 102 and the blue beam (B) 103 are switched to be selectively directed to the beam-splitting regions 21210, 21211, 21212 from the beam-splitting regions 21207, 21208, 21209. At this moment, the red beam (R) 101 is split by the beam-splitting region 21210 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the green beam (G) 102 is split by the beam-splitting region 21211 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the blue beam (B) 103 is split by the beam-splitting region 21212 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t5, the beam splitter part 212 is continuously moved in the direction denoted as the arrow A under control of the controlling device 500, so that the red beam (R) 101, the green beam (G) 102 and the blue beam (B) 103 are switched to be selectively directed to the beam-splitting regions 21213, 21214, 21215 from the beam-splitting regions 21210, 21211, 21212. At this moment, the blue beam (B) 103 is split by the beam-splitting region 21215 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the red beam (R) 101 is split by the beam-splitting region 21213 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the green beam (G) 102 is split by the beam-splitting region 21214 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t6, the beam splitter part 212 is continuously moved in the direction denoted as the arrow A under control of the controlling device 500, so that the red beam (R) 101, the green beam (G) 102 and the blue beam (B) 103 are switched to be selectively directed to the beam-splitting regions 21216, 21217, 21218 from the beam-splitting regions 21213, 21214, 21215. At this moment, the green beam (G) 102 is split by the beam-splitting region 21217 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the blue beam (B) 103 is split by the beam-splitting region 21218 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the red beam (R) 101 is split by the beam-splitting region 21216 and propagated through the beam combiner part 220 to generate light beams 613 and 616 that are substantially parallel with each other and have the third identical incident angle. The light beams 613 and 616 are focused onto the pixel 411 by the micro-lens 311.

Next, at the time spot t7, the process as described at the time spot t6 is performed.

At the time spot t8, the beam splitter part 212 is moved in the direction denoted as the arrow A′ under control of the controlling device 500, so that the red beam (R) 101, the green beam (G) 102 and the blue beam (B) 103 are switched to be selectively directed to the beam-splitting regions 21213, 21214, 21215 from the beam-splitting regions 21216, 21217, 21218. At this moment, the process as described at the time spot t5 is performed.

At the time spot t9, the beam splitter part 212 is continuously moved in the direction denoted as the arrow A′ under control of the controlling device 500, so that the red beam (R) 101, the green beam (G) 102 and the blue beam (B) 103 are switched to be selectively directed to the beam-splitting regions 21210, 21211, 21212 from the beam-splitting regions 21213, 21214, 21215. At this moment, the process as described at the time spot t4 is performed.

At the time spot t10, the beam splitter part 212 is continuously moved in the direction denoted as the arrow A′ under control of the controlling device 500, so that the red beam (R) 101, the green beam (G) 102 and the blue beam (B) 103 are switched to be selectively directed to the beam-splitting regions 21207, 21208, 21209 from the beam-splitting regions 21210, 21211, 21212. At this moment, the process as described at the time spot t3 is performed.

At the time spot t11, the beam splitter part 212 is continuously moved in the direction denoted as the arrow A′ under control of the controlling device 500, so that the red beam (R) 101, the green beam (G) 102 and the blue beam (B) 103 are switched to be selectively directed to the beam-splitting regions 21204, 21205, 21206 from the beam-splitting regions 21207, 21208, 21209. At this moment, the process as described at the time spot t2 is performed.

At the time spot t12, the beam splitter part 212 is continuously moved in the direction denoted as the arrow A′ under control of the controlling device 500, so that the red beam (R) 101, the green beam (G) 102 and the blue beam (B) 103 are switched to be selectively directed to the beam-splitting regions 21201, 21202, 21203 from the beam-splitting regions 21204, 21205, 21206. At this moment, the process as described at the time spot t1 is performed.

After the time spot t13, the beam splitter part 212 is continuously moved under control of the controlling device 500 and the processes as described at t1˜t12 are cyclically repeated. In addition, the colors of the light beams received by the pixels at different time spots may be altered depending on the split beam projecting device 300.

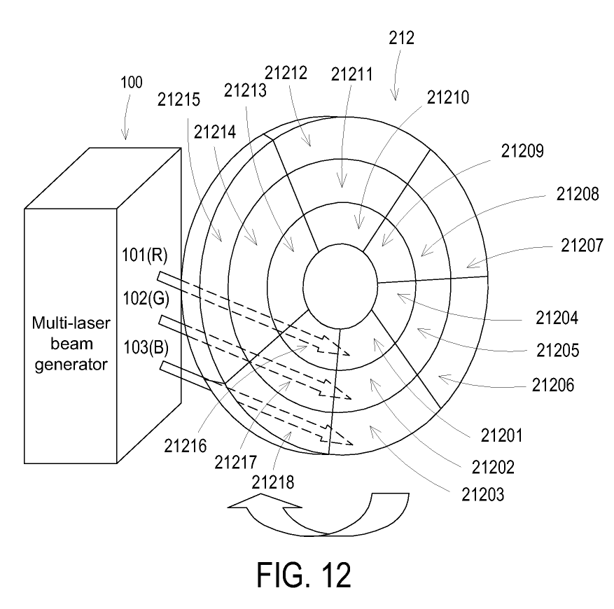

FIG. 12 is a schematic view illustrating a rotation-type beam splitter part of a mechanical beam switching device for splitting the incident light beams according to the second preferred embodiment of the present invention. The multi-laser beam generator 100 comprises three laser beam generating units for respectively generating a red beam (R) 101, a green beam (G) 102 and a blue beam (B) 103. The rotation-type beam splitter part 212 has a plurality of beam-splitting regions 21201˜21218. Please refer to FIGS. 1, 10, and 12 and the table 2-2.

At the time spot t1, the blue beam (B) 103 is split by the beam-splitting region 21203 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the green beam (G) 102 is split by the beam-splitting region 21202 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the red beam (R) 101 is split by the beam-splitting region 21201 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t2, the beam splitter part 212 is rotated in a clockwise direction under control of the controlling device 500, so that the red beam (R) 101, the green beam (G) 102 and the blue beam (B) 103 are switched to be selectively directed to the beam-splitting regions 21204, 21205, 21206 from the beam-splitting regions 21201, 21202, 21203. At this moment, the red beam (R) 101 is split by the beam-splitting region 21204 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the blue beam (B) 103 is split by the beam-splitting region 21206 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the green beam (G) 102 is split by the beam-splitting region 21205 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t3, the beam splitter part 212 is continuously rotated in a clockwise direction under control of the controlling device 500, so that the red beam (R) 101, the green beam (G) 102 and the blue beam (B) 103 are switched to be selectively directed to the beam-splitting regions 21207, 21208, 21209 from the beam-splitting regions 21204, 21205, 21206. At this moment, the green beam (G) 102 is split by the beam-splitting region 21208 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the red beam (R) 101 is split by the beam-splitting region 21207 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the blue beam (B) 103 is split by the beam-splitting region 21209 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t4, the beam splitter part 212 is continuously rotated in a clockwise direction under control of the controlling device 500, so that the red beam (R) 101, the green beam (G) 102 and the blue beam (B) 103 are switched to be selectively directed to the beam-splitting regions 21210, 21211, 21212 from the beam-splitting regions 21207, 21208, 21209. At this moment, the red beam (R) 101 is split by the beam-splitting region 21210 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the green beam (G) 102 is split by the beam-splitting region 21211 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the blue beam (B) 103 is split by the beam-splitting region 21212 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t5, the beam splitter part 212 is continuously rotated in a clockwise direction under control of the controlling device 500, so that the red beam (R) 101, the green beam (G) 102 and the blue beam (B) 103 are switched to be selectively directed to the beam-splitting regions 21213, 21214, 21215 from the beam-splitting regions 21210, 21211, 21212. At this moment, the blue beam (B) 103 is split by the beam-splitting region 21215 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the red beam (R) 101 is split by the beam-splitting region 21213 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the green beam (G) 102 is split by the beam-splitting region 21214 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t6, the beam splitter part 212 is continuously rotated in a clockwise direction under control of the controlling device 500, so that the red beam (R) 101, the green beam (G) 102 and the blue beam (B) 103 are switched to be selectively directed to the beam-splitting regions 21216, 21217, 21218 from the beam-splitting regions 21213, 21214, 21215. At this moment, the green beam (G) 102 is split by the beam-splitting region 21217 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the blue beam (B) 103 is split by the beam-splitting region 21218 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the red beam (R) 101 is split by the beam-splitting region 21216 and propagated through the beam combiner part 220 to generate light beams 613 and 616 that are substantially parallel with each other and have the third identical incident angle. The light beams 613 and 616 are focused onto the pixel 411 by the micro-lens 311.

After the time spot t7, the beam splitter part 212 is the beam splitter part 212 is continuously rotated in a clockwise direction under control of the controlling device 500, so that the red beam (R) 101, the green beam (G) 102 and the blue beam (B) 103 are switched to be selectively directed to the beam-splitting regions 21216, 21217, 21218 from the beam-splitting regions 21201, 21202, 21203. The processes as described at t1˜t6 are cyclically repeated. In addition, the colors of the light beams received by the pixels at different time spots may be altered depending on the split beam projecting device 300.

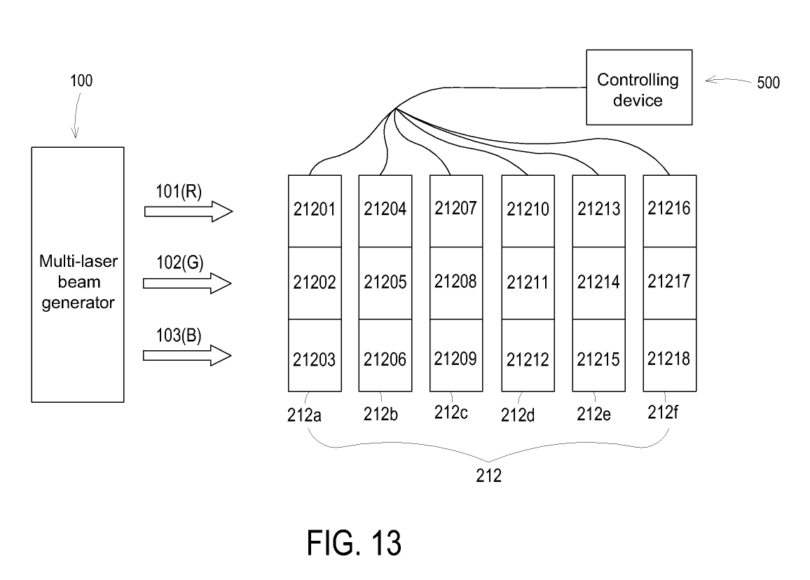

FIG. 13 is a schematic view illustrating a beam splitter part of an electronic beam switching device for splitting the incident light beams according to the second preferred embodiment of the present invention. The multi-laser beam generator 100 comprises three laser beam generating units for respectively generating a red beam (R) 101, a green beam (G) 102 and a blue beam (B) 103. The beam splitter part 212 of the electronic beam switching device 200 has a plurality of beam-splitting regions 21201˜21218. The beam-splitting regions 21201, 21202 and 21203 are disposed on a first carrier 212a. The beam-splitting regions 21204, 21205 and 21206 are disposed on a second carrier 212b. The beam-splitting regions 21204, 21205 and 21206 are disposed on a second carrier 212b and respectively aligned with the beam-splitting regions 21201, 21202 and 21203 of the first carrier 212a. The beam-splitting regions 21207, 21208 and 21209 are disposed on a third carrier 212c and respectively aligned with the beam-splitting regions 21204, 21205 and 21206 of the second carrier 212b. The beam-splitting regions 21210, 21211 and 21212 are disposed on a fourth carrier 212d and respectively aligned with the beam-splitting regions 21207, 21208 and 21209 of the third carrier 212c. The beam-splitting regions 21213, 21214 and 21215 are disposed on a fifth carrier 212e and respectively aligned with the beam-splitting regions 21210, 21211 and 21212 of the fourth carrier 212d. The beam-splitting regions 21216, 21217 and 21218 are disposed on a fifth carrier 212e and respectively aligned with the beam-splitting regions 21213, 21214 and 21215 of the fifth carrier 212e. Please refer to FIGS. 1, 10, and 13 and the table 2-2.

At the time spot t1, the beam-splitting regions 21201, 21202 and 21203 of the beam splitter part 212 are turned on but the beam-splitting regions 21204˜21218 of the beam splitter part 212 are turned off under control of the controlling device 500. At this moment, the blue beam (B) 103 is split by the beam-splitting region 21203 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the green beam (G) 102 is split by the beam-splitting region 21202 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the red beam (R) 101 is split by the beam-splitting region 21201 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t2, the beam-splitting regions 21204, 21205 and 21206 of the beam splitter part 212 are turned on but the beam-splitting regions 21201˜21203 and 21207˜21218 of the beam splitter part 212 are turned off under control of the controlling device 500. At this moment, the red beam (R) 101 is split by the beam-splitting region 21204 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the blue beam (B) 103 is split by the beam-splitting region 21206 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the green beam (G) 102 is split by the beam-splitting region 21205 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t3, the beam-splitting regions 21207, 21208 and 21209 of the beam splitter part 212 are turned on but the beam-splitting regions 21201˜21206 and 21210˜21218 of the beam splitter part 212 are turned off under control of the controlling device 500. At this moment, the green beam (G) 102 is split by the beam-splitting region 21208 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the red beam (R) 101 is split by the beam-splitting region 21207 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the blue beam (B) 103 is split by the beam-splitting region 21209 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t4, the beam-splitting regions 21210, 21211 and 21212 of the beam splitter part 212 are turned on but the beam-splitting regions 21201˜21209 and 21213˜21218 of the beam splitter part 212 are turned off under control of the controlling device 500. At this moment, the red beam (R) 101 is split by the beam-splitting region 21210 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the green beam (G) 102 is split by the beam-splitting region 21211 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the blue beam (B) 103 is split by the beam-splitting region 21212 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t5, the beam-splitting regions 21213, 21214 and 21215 of the beam splitter part 212 are turned on but the beam-splitting regions 21201˜21212 and 21216˜21218 of the beam splitter part 212 are turned off under control of the controlling device 500. At this moment, the blue beam (B) 103 is split by the beam-splitting region 21215 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the red beam (R) 101 is split by the beam-splitting region 21213 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the green beam (G) 102 is split by the beam-splitting region 21214 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t6, the beam-splitting regions 21216, 21217 and 21218 of the beam splitter part 212 are turned on but the beam-splitting regions 21201˜21215 of the beam splitter part 212 are turned off under control of the controlling device 500. At this moment, the green beam (G) 102 is split by the beam-splitting region 21217 and propagated through the beam combiner part 220 to generate light beams 611 and 614 that are substantially parallel with each other and have the first identical incident angle. The light beams 611 and 614 are focused onto the pixel 413 by the micro-lens 311. At this moment, the blue beam (B) 103 is split by the beam-splitting region 21218 and propagated through the beam combiner part 220 to generate light beams 612 and 615 that are substantially parallel with each other and have the second identical incident angle. The light beams 612 and 615 are focused onto the pixel 412 by the micro-lens 311. At this moment, the red beam (R) 101 is split by the beam-splitting region 21216 and propagated through the beam combiner part 220 to generate light beams 613 and 616 that are substantially parallel with each other and have the third identical incident angle. The light beams 613 and 616 are focused onto the pixel 411 by the micro-lens 311.

At the time spot t7, the beam-splitting regions 21201, 21202 and 21203 of the beam splitter part 212 are turned on but the beam-splitting regions 21204˜21218 of the beam splitter part 212 are turned off under control of the controlling device 500. The processes as described at t1˜t6 are cyclically repeated. In addition, the colors of the light beams received by the pixels at different time spots may be altered depending on the split beam projecting device 300.

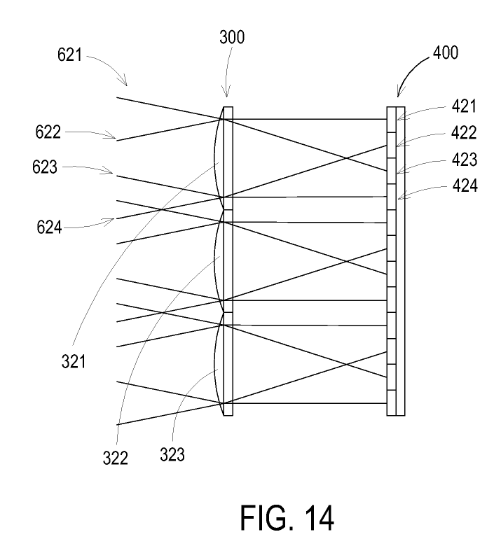

FIG. 14 is a schematic view illustrating an assembly of a split beam projecting device and transmissive light valve of FIG. 1 for receiving different beams at different incident angles according to a third preferred embodiment of the present invention. Please refer to FIGS. 1, 2A and 14. The split beam projecting device 300 is composed of a plurality of micro-lenses (as shown in FIG. 2A) or a plurality of micro-cylindrical lenses (as shown in FIG. 2B). Each micro-lens or micro-cylindrical lens is aligned with fourth pixels along the x-axis direction of the transmissive light valve 400. For example, the micro-lens 321 is aligned with three pixels 421, 422, 423 and 424. As for the micro-lens 321 of the split beam projecting device 300, four light beams 621, 622, 623 and 624 from the beam switching device 200 are directed to the micro-lens 321 of the split beam projecting device 300 at two different incident angles. As shown in FIG. 14, the light beams 621 and 623 are substantially parallel with each other and have a substantially identical incident angle with respect to the micro-lens 321, so that the light beams 621 and 623 are respectively focused onto the pixels 423 and 424 of the transmissive light valve 400 by the micro-lens 321. In addition, the light beams 622 and 624 are substantially parallel with each other and have a substantially identical incident angle with respect to the micro-lens 321, in which the incident angle of the light beams 621 and 623 and the incident angle of the light beams 622 and 624 are different. Consequently, the light beams 622 and 624 are respectively focused onto the pixels 421 and 422 of the transmissive light valve 400 by the micro-lens 321. The processes of focusing other light beams onto other pixels of the transmissive light valve 400 by the micro-lenses 322 and 323 are identical to that described for the micro-lens 321, and are not redundantly described herein. In accordance with a key feature of the present invention, the first set of light beams 621/623 and the second set of light beams 622/624 of different incident angles are switched between different color beams at different time spots by the beam switching device 200.

An approach of directing light beams by the split beam projecting device 300 and the transmissive light valve 400 of FIG. 14 will be illustrated as follows.

At the time spot t1, the light beams 621 and 623 (e.g. green beams) that are substantially parallel with each other and have a first identical incident angle are respectively focused onto the pixel 423 and 424 by the micro-lens 321. At this moment, the light beams 622 and 624 (e.g. red beams) that are substantially parallel with each other and have a second identical incident angle are respectively focused onto the pixel 421 and 422 by the micro-lens 321. The processes of focusing other light beams onto other pixels of the transmissive light valve 400 by the micro-lenses 322 and 323 are identical to that described for the micro-lens 321, and are not redundantly described herein.

Next, at the time spot t2, the light beams 621 and 623 (e.g. green beams) that are substantially parallel with each other and have the first identical incident angle are respectively focused onto the pixel 423 and 424 by the micro-lens 321. At this moment, the light beams 622 and 624 (e.g. red beams) that are substantially parallel with each other and have the second identical incident angle are respectively focused onto the pixel 421 and 422 by the micro-lens 321.

Next, at the time spot t3, the light beams 621 and 623 (e.g. red beams) that are substantially parallel with each other and have the first identical incident angle are respectively focused onto the pixel 423 and 424 by the micro-lens 321. At this moment, the light beams 622 and 624 (e.g. green beams) that are substantially parallel with each other and have the second identical incident angle are respectively focused onto the pixel 421 and 422 by the micro-lens 321.

Next, at the time spot t4, the light beams 621 and 623 (e.g. blue beams) that are substantially parallel with each other and have the first identical incident angle are respectively focused onto the pixel 423 and 424 by the micro-lens 321. At this moment, the light beams 622 and 624 (e.g. green beams) that are substantially parallel with each other and have the second identical incident angle are respectively focused onto the pixel 421 and 422 by the micro-lens 321.

After the time spot t5, the processes as described at t1˜t4 are cyclically repeated according to the table 3-1. By means of time integration, it is found that the red, green and blue beams are all irradiated onto all pixels 421, 422, . . . , and so on. In other words, the brightness and the resolution are not impaired.

TABLE 3-1

Time

| Pixel | t1 | t2 | t3 | t4 | t5 | . . . |
|---|---|---|---|---|---|---|
| 421 | R | B | G | G | R | . . . |
| 422 | R | B | G | G | R | . . . |
| 423 | G | G | R | B | G | . . . |
| 424 | G | G | R | B | G | . . . |
| . | R | B | G | G | R | . . . |
| . | | | | | | |
| . | | | | | | |
| . | R | B | G | G | R | . . . |
| . | | | | | | |
| . | | | | | | |
| . | . | . | . | . | . | . . . |
| . | . | . | . | . | . | |
| . | . | . | . | . | . | |

In the same way, the colors of the light beams received by the pixels 421, 422, . . . at different time spots may be altered in the sequence as shown in the tables 3-2 and 3-3. The processes of directing the light beams listed in the tables 3-2 and 3-3 are identical to those illustrated in the table 3-1, and are not redundantly described herein.

TABLE 3-2

Time

| Pixel | t1 | t2 | t3 | t4 | t5 | . . . |
|---|---|---|---|---|---|---|
| 421 | B | G | R | B | B | . . . |
| 422 | B | G | R | B | B | . . . |
| 423 | R | R | B | G | R | . . . |
| 424 | R | R | B | G | R | . . . |
| . | B | G | R | R | B | . . . |
| . | | | | | | |
| . | | | | | | |
| . | B | G | R | R | B | . . . |
| . | | | | | | |
| . | | | | | | |
| . | . | . | . | . | . | . . . |
| . | . | . | . | . | . | |
| . | . | . | . | . | . | |

TABLE 3-3

Time

| Pixel | t1 | t2 | t3 | t4 | t5 | . . . |
|---|---|---|---|---|---|---|
| 421 | G | R | B | B | G | . . . |
| 422 | G | R | B | B | G | . . . |
| 423 | B | B | G | R | B | . . . |
| 424 | B | B | G | R | B | . . . |
| . | G | R | B | B | G | . . . |
| . | | | | | | |
| . | | | | | | |
| . | G | R | B | B | G | . . . |
| . | | | | | | |
| . | | | | | | |
| . | . | . | . | . | . | . . . |
| . | . | . | . | . | . | |
| . | . | . | . | . | . | |

An exemplary beam switching device 200 used in this embodiment includes but is not limited to a mechanical beam switching device or an electronic beam switching device. Regardless of whether a mechanical beam switching device or an electronic beam switching device is adopted, the beam switching device 200 comprises a beam splitter part 210 and a beam combiner part 220. An example of the beam splitter part 210 is a holographic diffraction element for splitting the incident light beams into a plurality of light beams of different emergent angles. The light beams of different emergent angles are received by the beam combiner part 220 and combined into the common optical path such that the red beam, the green beam and the blue beam of different emergent angles can be directed to the split beam projecting device 300. In a case that the beam switching device 200 is a mechanical beam switching device, the beam splitter part 210 can split the incident light beams in a vibration or rotation way. The vibration-type and rotation-type beam splitter parts use holographic diffraction elements at different regions to split light beams of different emergent angles. The configurations and the operations of the beam switching device 200 are similar to those illustrated above, and are not redundantly described herein.

It is noted that, however, those skilled in the art will readily observe that numerous modifications and alterations may be made while retaining the teachings of the invention. In some embodiments, each micro-lens of the split beam projecting device is aligned with six pixels, wherein these six pixels are divided into two sets and each set includes three pixels. In some embodiments, each micro-lens of the split beam projecting device is aligned with six pixels, wherein these six pixels are divided into three sets and each set includes two pixels. In some embodiments, each micro-lens of the split beam projecting device is aligned with nine pixels, wherein these nine pixels are divided into three sets and each set includes three pixels.

Please refer to FIG. 1 again. The red beam 101, the green beam 102 and the blue beam 103 from the multi-laser beam generator 100 are split into a plurality of light beams of different emergent angles by the beam splitter part 210 of the beam switching device 200. The light beams of different emergent angles are received by the beam combiner part 220 of the beam switching device 200 and combined into the common optical path such that the red beam, the green beam and the blue beam of different emergent angles can be directed to the split beam projecting device 300. Regardless of whether the beam splitter part 210 is a mechanical beam splitter part or an electronic beam splitter part, the same beam combiner part 220 can be employed to combine the green beam 102 and the blue beam 103 into the common optical path. As a consequence, the angles of the red beam 101, the green beam 102 and the blue beam 103 to be directed to the split beam projecting device 300 are adjusted depending on the split beam projecting device 300 but these beams are propagated along the common optical path.

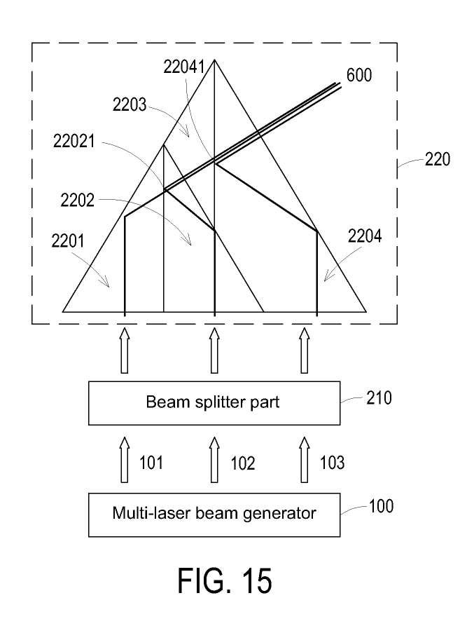

Hereinafter, some exemplary beam combiner parts of the beam switching device will be illustrated with reference to FIGS. 15, 16, 17 and 18.

FIG. 15 is a schematic view illustrating a first exemplary beam combiner part used in the projection system of the present invention. The beam combiner part 220 of FIG. 15 is composed of multiple prisms. In this embodiment, the beam combiner part 220 comprises a first prism 2201, a second prism 2202, a third prism 2203, and a fourth prism 2204. The first prism 2201 and the second prism 2202 may be bonded together or separated from each other. The third prism 2203 and the fourth prism 2204 may be bonded together or separated from each other. However, the second prism 2202 is separated from the third prism 2203 by a gap; and the second prism 2202 is also separated from the fourth prism 2204 by a gap. As a consequence, the green beam 102 is subject to a total reflection by the second prism 2202 and a reflection by a color splitting coating 22021, and permitted to be transmitted through the third prism 2203 and the color splitting coating 22041. In addition, the red beam 101 is subject to a total reflection by the first prism 2201, and permitted to be transmitted through the color splitting coating 22021, the second prism 2202, the third prism 2203 and the color splitting coating 22041. The blue beam 103 is subject to a total reflection by the fourth prism 2204 and a reflection by the color splitting coating 22041. By means of the prisms of the beam combiner part 220, the light beams 600 of various incident angles are directed to the split beam projecting device 300. For clarification, the light beams 600 indicate the light beams 601, 602, . . . , 611, 612 . . . , 621, 622 . . . ) that are issued by the beam switching device 200. Depending on the split beam projecting device 300, the incident angles of the light beams 600 are adjustable. It is noted that, however, those skilled in the art will readily observe that numerous modifications and alterations may be made while retaining the teachings of the invention. For example, the positions of the light sources of the multi-laser beam generator 100 for emitting the red beam 101, the green beam 102 and the blue beam 103 are changeable.

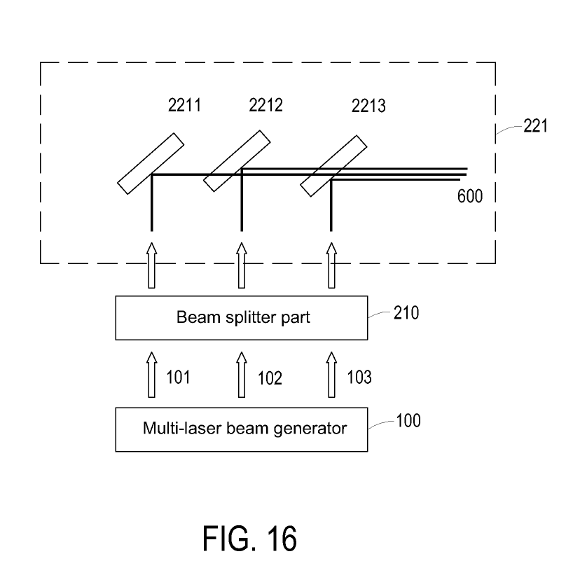

FIG. 16 is a schematic view illustrating a second exemplary beam combiner part used in the projection system of the present invention. The beam combiner part 221 of FIG. 16 is composed of multiple color beam splitters or reflective mirrors. In this embodiment, the beam combiner part 221 comprises a first color beam splitter or reflective mirror 2211, a second color beam splitter or reflective mirror 2212, and a third color beam splitter or reflective mirror 2213. The first color beam splitter or reflective mirror 2211 is a red beam splitter or reflective mirror. The red beam is permitted to be reflected by the first color beam splitter or reflective mirror 2211. The second color beam splitter or reflective mirror 2212 is a green beam splitter or reflective mirror. The green beam is permitted to be reflected by the second color beam splitter or reflective mirror 2212 but the red beam is permitted to be transmitted through the second color beam splitter or reflective mirror 2212. The third color beam splitter or reflective mirror 2213 is a blue beam splitter or reflective mirror. The blue beam is permitted to be reflected by the third color beam splitter or reflective mirror 2213 but the red and green beams are permitted to be transmitted through the third color beam splitter or reflective mirror 2213. The first color beam splitter or reflective mirror 2211, the second color beam splitter or reflective mirror 2212 and the third color beam splitter or reflective mirror 2213 are orderly arranged along the optical paths of the red, green and blue beams. The red beam 101 is reflected by the first color beam splitter or reflective mirror 2211 but transmitted through the second color beam splitter or reflective mirror 2212 and the third color beam splitter or reflective mirror 2213. The green beam 102 is reflected by the second color beam splitter or reflective mirror 2212 but transmitted through the third color beam splitter or reflective mirror 2213. The blue beam 103 is reflected by the third color beam splitter or reflective mirror 2213. By means of the color beam splitters or reflective mirrors of the beam combiner part 221, the light beams 600 of various incident angles are directed to the split beam projecting device 300. For clarification, the light beams 600 indicate the light beams 601, 602, . . . , 611, 612 . . . , 621, 622 . . . ) that are issued by the beam switching device 200. Depending on the split beam projecting device 300, the incident angles of the light beams 600 are adjustable. It is noted that, however, those skilled in the art will readily observe that numerous modifications and alterations may be made while retaining the teachings of the invention. For example, the positions of the light sources of the multi-laser beam generator 100 for emitting the red beam 101, the green beam 102 and the blue beam 103 are changeable.

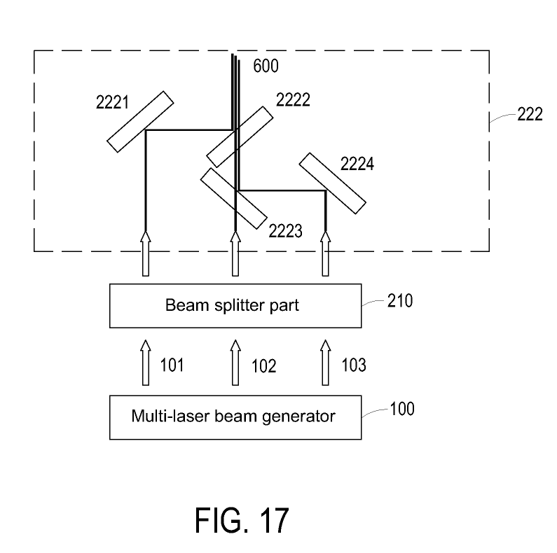

FIG. 17 is a schematic view illustrating a third exemplary beam combiner part used in the projection system of the present invention. The beam combiner part 222 of FIG. 17 is also composed of multiple color beam splitters or reflective mirrors. In this embodiment, the beam combiner part 222 includes a first color beam splitter or reflective mirror 2221, a second color beam splitter or reflective mirror 2222, a third color beam splitter or reflective mirror 2223, and a fourth color beam splitter or reflective mirror 2224. The first color beam splitter or reflective mirror 2221 is a red beam splitter or reflective mirror. The red beam is permitted to be reflected by the first color beam splitter or reflective mirror 2221. The second color beam splitter or reflective mirror 2222 is also a red beam splitter or reflective mirror. The red beam is permitted to be reflected by the second color beam splitter or reflective mirror 2222 but the green and blue beams are permitted to be transmitted through the second color beam splitter or reflective mirror 2222. The third color beam splitter or reflective mirror 2223 is a blue beam splitter or reflective mirror. The blue beam is permitted to be reflected by the third color beam splitter or reflective mirror 2223 but the red and green beams are permitted to be transmitted through the third color beam splitter or reflective mirror 2223. The fourth color beam splitter or reflective mirror 2224 is also a blue beam splitter or reflective mirror. The blue beam is permitted to be reflected by the fourth color beam splitter or reflective mirror 2224. The first color beam splitter or reflective mirror 2221 is arranged along the optical path of the red beam 101. The color beam splitter or reflective mirrors 2222 and 2223 are orderly arranged along the optical path of the green beam 102. The fourth color beam splitter or reflective mirror 2224 is arranged along the optical path of the blue beam 103. The color beam splitter or reflective mirrors 2222 and 2223 are differentially tilted. The red beam 101 is successively reflected by the first color beam splitter or reflective mirror 2221 and the second color beam splitter or reflective mirror 2222. The green beam 102 is successively transmitted through the third color beam splitter or reflective mirror 2223 and the second color beam splitter or reflective mirror 2222. The blue beam 103 is successively reflected by the fourth color beam splitter or reflective mirror 2224 and the third color beam splitter or reflective mirror 2223, and transmitted through the second color beam splitter or reflective mirror 2222. By means of the color beam splitters or reflective mirrors of the beam combiner part 222, the light beams 600 of various incident angles are directed to the split beam projecting device 300. For clarification, the light beams 600 indicate the light beams 601, 602, . . . , 611, 612 . . . , 621, 622 . . . ) that are issued by the beam switching device 200. Depending on the split beam projecting device 300, the incident angles of the light beams 600 are adjustable. It is noted that, however, those skilled in the art will readily observe that numerous modifications and alterations may be made while retaining the teachings of the invention. For example, the positions of the light sources of the multi-laser beam generator 100 for emitting the red beam 101, the green beam 102 and the blue beam 103 are changeable.

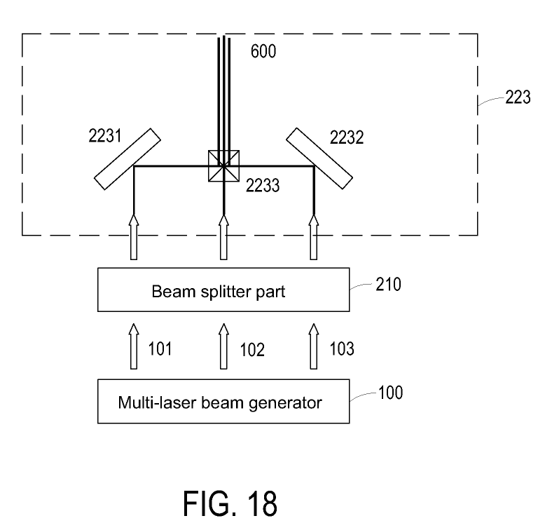

FIG. 18 is a schematic view illustrating a fourth exemplary beam combiner part used in the projection system of the present invention. The beam combiner part 223 of FIG. 18 is composed of multiple color beam splitters or reflective mirrors and at least one cube prism. In this embodiment, the beam combiner part 223 comprises a first color beam splitter or reflective mirror 2231, a second color beam splitter or reflective mirror 2232, and a cube prism 2233. The first color beam splitter or reflective mirror 2231 is a red beam splitter or reflective mirror. The red beam is permitted to be reflected by the first color beam splitter or reflective mirror 2231. The second color beam splitter or reflective mirror 2232 is a blue beam splitter or reflective mirror. The blue beam is permitted to be reflected by the second color beam splitter or reflective mirror 2232. The red, green and blue beams are permitted to be incident into three sides of the cube prism 2233 and emergent from another side of the cube prism 2233. In this embodiment, the first color beam splitter or reflective mirror 2231, the second color beam splitter or reflective mirror 2232, and the cube prism 2233 are arranged along the optical paths of the red beam 101, the green beam 102 and the blue beam 103. The red beam 101 is permitted to be reflected by the first color beam splitter or reflective mirror 2231 and incident into a corresponding side of the cube prism 2233. The green beam 102 is permitted to be transmitted through the opposite side of the cube prism 2233. The blue beam 103 is permitted to be reflected by the second color beam splitter or reflective mirror 2232 and incident into a corresponding side of the cube prism 2233. By means of the color beam splitters or reflective mirrors and the cube prism of the beam combiner part 223, the light beams 600 of various incident angles are directed to the split beam projecting device 300. For clarification, the light beams 600 indicate the light beams 601, 602, . . . , 611, 612 . . . , 621, 622 . . . ) that are issued by the beam switching device 200. Depending on the split beam projecting device 300, the incident angles of the light beams 600 are adjustable. It is noted that, however, those skilled in the art will readily observe that numerous modifications and alterations may be made while retaining the teachings of the invention. For example, the positions of the light sources of the multi-laser beam generator 100 for emitting the red beam 101, the green beam 102 and the blue beam 103 are changeable.

From the above description, the projection system of the present invention can meet the requirements of high brightness, high resolution, small size and low power consumption. The projection system of the present invention uses laser sources to replace the conventional ultra high pressure mercury lamps or the light emitting diodes. The projection system has simplified configurations while achieving the power-saving purpose. On the other hand, since the micro-lens array is arranged in front of the transmissive light valve, the brightness is no longer impaired. The light beams of different incident angles that are emitted by laser sources are directed to the micro-lens array. Since the angle deviation can be controlled within a specified range, the efficiency is largely increased. In a case that the red beam, the green beam and the blue beam are respectively directed to the pixels of the transmissive light valve at incident angles a, b and c, the red beam, the green beam and the blue beam are respectively directed at incident angles b, c and a at the next time spot; and the red beam, the green beam and the blue beam are respectively directed at incident angles c, a and b at the further next time spot. Since the red beam, the green beam and the blue beam are directed onto the same pixel at different time spots, the resolution is no longer impaired. Moreover, the method of mechanically or electronically switching the incident angles of the light beams is simple and applicable.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A projection system comprising:
a multi-laser beam generator for selectively generating a red beam, a green beam and a blue beam;
a beam switching device for receiving said red, green and blue beams that are emitted by the multi-laser beam generator, splitting said red, green and blue beams into a plurality of light beams of different angles, and directing said red, green and blue beams of said different angles into a common optical path;
a split beam projecting device comprising a plurality of micro-lenses, wherein each micro-lens receives said red, green and blue beams of said different angles that are issued by said beam switching device; and
a transmissive light valve having a plurality of pixels for receiving said red, green and blue beams that are guided by said split beam projecting device, wherein said red, green and blue beams of said different angles are received by said micro-lenses of said split beam projecting device and guided onto said pixels of said transmissive light valve for imagining on said pixels.

2. The projection system according to claim 1 wherein said projection system is a single-panel transmissive projection system.

3. The projection system according to claim 1 further comprising a controlling device electrically connected to said multi-laser beam generator, said beam switching device and said transmissive light valve for controlling operations of said multi-laser beam generator, said beam switching device and said transmissive light valve.

4. The projection system according to claim 1 wherein said beam switching device comprises:
a beam splitter part comprising a holographic diffraction element for receiving said red, green and blue beams that are emitted by the multi-laser beam generator, splitting said red, green and blue beams into said plurality of light beams of said different angles; and
a beam combiner part for combining said red, green and blue beams issued by said beam splitter part into said common optical path such that said red, green and blue beams of said different angles are directed to said split beam projecting device.

5. The projection system according to claim 4 wherein said beam switching device is a mechanical beam switching device or an electronic beam switching device.

6. The projection system according to claim 5 wherein said beam splitter part of said mechanical beam switching device is a vibration-type beam splitter part or a rotation-type beam splitter part.

7. The projection system according to claim 4 wherein said beam splitter part comprises a plurality of beam-splitting regions.

8. The projection system according to claim 4 wherein said beam combiner part comprises multiple prisms.

9. The projection system according to claim 4 wherein said beam combiner part comprises multiple color beam splitters or reflective mirrors.

10. The projection system according to claim 4 wherein said beam combiner part comprises multiple color beam splitters or reflective mirrors and at least one cube prism.

11. The projection system according to claim 1 wherein each micro-lens of said split beam projecting device is aligned with multiple pixels of said transmissive light valve.

12. The projection system according to claim 11 wherein each micro-lens of said split beam projecting device is aligned with two, three, four, sixth or nine pixels of said transmissive light valve.

13. The projection system according to claim 11 wherein said light beams of said different angles that are issued by said beam switching device comprise a first angle beam and a second angle beam.

14. The projection system according to claim 13 wherein said first angle beam is periodically switched between said red, green and blue beams, and said second angle beam is periodically switched between said red, green and blue beams.

15. The projection system according to claim 14 wherein said first angle beam and said second angle beam are received by said micro-lenses and directed onto different ones of said pixels.

16. The projection system according to claim 11 wherein said light beams of said different angles that are issued by said beam switching device comprise a first angle beam, a second angle beam and a third angle beam.

17. The projection system according to claim 16 wherein said first angle beam is periodically switched between said red, green and blue beams, said second angle beam is periodically switched between said red, green and blue beams, and said third angle beam is periodically switched between said red, green and blue beams.

18. The projection system according to claim 17 wherein said first angle beam, said second angle beam and said third angle beam are received by said micro-lenses and directed onto different ones of said pixels.
